(19) United States
(12) Patent Application Publication
(10) Pub. No.: US 2019/0244799 A1
(43) Pub. Date: Aug. 8, 2019

(54) SYSTEMS INCLUDING A CELL ANALYZER COUPLED TO A MASS SPECTROMETER AND METHODS USING THE SYSTEMS

(71) Applicant: PERKINELMER HEALTH SCIENCES CANADA, INC., Woodbridge (CA)

(72) Inventors: Chady Stephan, Brampton (CA); Ruth Merrifield, Woodbridge (CA)

(21) Appl. No.: 16/209,130

(22) Filed: Dec. 4, 2018

Related U.S. Application Data
(63) Continuation-in-part of application No. 16/146,752, filed on Sep. 28, 2018.
Application No. 16/146,752 is a continuation of application No. 15/597,608, filed on May 17, 2017, now Pat. No. 10,147,592.
(60) Provisional application No. 62/596,811, filed on Dec. 9, 2017.
(60) Provisional application No. 62/337,997, filed on May 18, 2016.

(51) Int. Cl. H01J 49/10; H01J 49/04; G01N 30/72; H01J 49/16

(52) U.S. Cl. CPC H01J 49/107; H01J 49/045; H01J 49/167; H01J 49/049; G01N 30/7273

(57) ABSTRACT

Certain configurations of systems comprising a cell analyzer and a mass spectrometer are described. In some embodiments, the system can be used to determine both a cell phenotype or cellular response and an amount of at least one elemental species in the cell. The phenotype or other cellular characteristic and elemental content of each cell in a cell population can be determined and correlated.

### PRIORITY APPLICATION

This application is related to, and claims priority to and the benefit of, U.S. Provisional Application No. 62/596,811 filed on Dec. 9, 2017, the entire disclosure of which is hereby incorporated herein by reference for all purposes. This application is a continuation-in-part of U.S. application Ser. No. 16/146,752 filed on Sep. 28, 2018, which claims priority to U.S. application Ser. No. 15/597,608 filed on May 17, 2017.

### TECHNOLOGICAL FIELD

Certain configurations described herein are directed to the systems and methods that can differentiate cells and provide the differentiated cells to a mass spectrometer. More particularly, certain configurations described herein use flow cytometry and mass spectrometry coupled together to correlate an individual cell characteristic with an elemental level in the individual cell.

### BACKGROUND

The measurement of uptake of materials by live cells is often difficult to determine. In many instances, it is not possible to determine whether any one cell actually takes in a particular substance or material to which the cell is exposed.

### SUMMARY

In one aspect, a method comprising providing an individual cell in a cell population from a cell analyzer to a mass spectrometer to quantify an amount of at least a first element in the provided individual cell, and correlating the quantified amount of the first element in the provided individual cell with a measurement of the individual cell from the cell analyzer.

In certain examples, the method comprises quantifying an amount of the first element in each cell of the cell population using the mass spectrometer and correlating the quantified amount of the first element in each of the cells with individual cell measurements from the cell analyzer. In some embodiments, the method comprises using the quantified amount of the first element in each of the cells and the individual cell measurements from the cell analyzer to determine a number of the cells in the cell population that comprise the first element. In other instances, the method comprises using the quantified amount of the first element in each of the cells and the individual cell measurements from the cell analyzer to determine a number of the cells in the cell population exhibiting a selected biological response. In some examples, the method comprises using the quantified amount of the first element in each of the cells and the individual cell measurements from the cell analyzer to correlate cell size with the quantified amount of the first element. In some embodiments, the method comprises quantifying at least a second element in each cell of the cell population.

In other examples, the method comprises configuring the cell population as a unicellular suspension prior to providing the unicellular suspension to the cell analyzer. In some embodiments, the method comprises configuring the cell analyzer to provide unicellular eukaryotic cells to the mass spectrometer or unicellular prokaryotic cells to the mass spectrometer.

In some embodiments, the method comprises configuring the cell analyzer as a flow cytometer, a fluorescence activated cell sorter or a magnetic sorter. In certain configurations, the method comprises configuring the mass spectrometer to comprise an inductively coupled plasma. In other examples, the method comprises comprising separating the cell population from other species using chromatography prior to providing the cell population to the cell analyzer. In some examples, the method comprises determining cell size as the measurement of the individual cell from the cell analyzer. In certain examples, the method comprises determining cell viability as the measurement of the individual cell from the cell analyzer. In some examples, the method comprises determining cell phenotype using a specific label as the measurement of the individual cell from the cell analyzer. In some examples, the method comprises determining cell health using a specific label as the measurement of the individual cell from the cell analyzer. In some examples, the method comprises configuring the cells to comprise an average size of about 0.2 to 100 microns, configuring the cell analyzer as a flow cytometer and configuring the mass spectrometer to comprise an inductively coupled plasma.

In certain examples, the method comprises isolating organelles from the cell population, providing an individual organelle from the isolated organelles to a mass spectrometer from the cell analyzer to quantify an amount of the first element in the provided individual organelle, and correlating the quantified amount of the first element in the individual organelle with a measurement of the individual organelle from the cell analyzer.

In some examples, the method comprises using a processor to correlate the quantified amount of the at least the first element in the provided individual cell with the measurement of the individual cell from the cell analyzer.

In another aspect, a method of determining uptake of a first metal agent into cells comprises exposing a cell population to the first metal agent, determining a phenotype of individuals cells in the cell population using a cell analyzer, providing individual cells from the cell analyzer to a mass spectrometer fluidically coupled to the cell analyzer to quantify an amount of the first metal agent taken into each of the provided individual cells, and correlating the quantified amount of the first metal agent taken into each of the individual cells with the determined phenotype of each of the individual cells.

In certain examples, the method comprises configuring the mass spectrometer to comprise an inductively coupled plasma. In other examples, the method comprises selecting the first metal agent to be a transition metal agent or a metal agent comprising an element with an atomic mass from 2 to 285 amu's. In some embodiments, the method comprises selecting the transition metal agent to be a DNA replication inhibitor and selecting the cell population to be human cells. In certain examples, the method comprises quantifying an amount of cells of the cell population that are resistant to uptake of the transition metal agent using the quantified amount of the metal agent in the individual cells and the determined phenotype of each of the individual cells of the cell population.

In some examples, the method comprises exposing the cells to a second metal agent, wherein the second metal agent comprises a different metal than the first metal agent, determining a phenotype of individuals cells in the cell population exposed to the second metal agent using a cell analyzer, providing individual cells from the cell analyzer to the mass spectrometer fluidically coupled to the cell analyzer to quantify an amount of the second metal agent taken into each of the provided individual cells, and correlating the quantified amount of the second metal agent taken into each of the individual cells with the determined phenotype of each of the individual cells. In some examples, the method comprises quantifying an amount of cells of the cell population that are resistant to uptake of the second metal agent using the quantified amount of the second metal agent in the individual cells and the determined phenotype of each of the individual cells of the cell population.

In other examples, the method comprises configuring the cell analyzer as one of a flow cytometer, a fluorescence activated cell sorter and a magnetic sorter. In some examples, the method comprises determining one or more of cell size or cell viability as the determined phenotype of the cell. In some examples, the method comprises labeling the cells with a specific label to determine the phenotype of the cell.

In another aspect, a system configured to correlate an amount of a first element in a cell with a cell phenotype is described. In some examples, the system comprises a cell analyzer configured to provide an individual cell from a cell population and to determine a cell measurement of the provided individual cell, a mass spectrometer fluidically coupled to the cell analyzer and configured to receive the provided individual cell from the cell analyzer, wherein the mass spectrometer is configured to determine an amount of the first element present in the provided individual cell, and a processor configured to correlate the determined cell measurement of the provided individual cell with the determined amount of the first element present in the provided individual cell.

In certain embodiments, the cell analyzer is configured as a flow cytometer. In other embodiments, the mass spectrometer comprises an inductively coupled plasma. In some examples, the system comprises a cell introduction device fluidically coupled to the flow cytometer, e.g., a the cell introduction device comprises a loop configured to provide cells to the flow cytometer in a linear flow. In some examples, the cell introduction device further comprises a syringe. In certain embodiments, the cell introduction device comprises an autosampler. In other examples, the cell analyzer is configured as a fluorescence activated cell sorter or a magnetic cell sorter.

In some examples, the system comprises a sample introduction device fluidically coupled to each of the cell analyzer and the mass spectrometer, wherein the sample introduction device is configured to receive the individual cell from the cell analyzer and provide the received individual cell to the mass spectrometer. In some embodiments, the sample introduction device comprises a spray chamber.

In certain examples, the mass spectrometer is configured to determine an amount of a first metal as the first element. In other examples, the mass spectrometer comprises an ionization source fluidically coupled to the spray chamber, a mass analyzer fluidically coupled to the ionization source, and a detector fluidically coupled to the mass analyzer.

In some embodiments, the cell analyzer is configured to determine cell size and the processor is configured to correlate the determined cell size of the individual cell with the determined amount of the first element present in the provided individual cell.

In other embodiments, the cell analyzer is configured to determine cell viability and the processor is configured to correlate the determined cell viability of the individual cell with the determined amount of the first element present in the provided individual cell.

In additional instances, the cell analyzer is configured to determine cell phenotype and the processor is configured to correlate the determined cell phenotype of the individual cell with the determined amount of the first element present in the provided individual cell.

Additional aspects, embodiments, examples, features, and configurations are described in more detail below.

### BRIEF DESCRIPTION OF THE SEVERAL VIEWS OF THE DRAWINGS

Certain specific configurations of systems and methods are described with reference to the accompanying figures in which:

FIG. 1 is an illustration of a cell analyzer fluidically coupled to a mass spectrometer, in accordance with certain examples;

FIG. 2 is an illustration of a flow cytometer fluidically coupled to a mass spectrometer, in accordance with some examples;

FIG. 3 is an illustration of a fluorescence activated cell sorter fluidically coupled to two mass spectrometers, in accordance with certain configurations;

FIG. 4 is an illustration of a system comprising a cell analyzer and a mass analyzer, in accordance with some embodiments;

FIG. 5 is an illustration of one sample introduction device, in accordance with certain embodiments;

FIG. 6 is an illustration of a torch and induction coil configured to sustain an inductively coupled plasma, in accordance with some examples;

FIG. 7 is an illustration of a torch and plate electrodes configured to sustain an inductively coupled plasma, in accordance with certain configurations;

FIG. 8 is an illustration of a torch and induction coil comprising a radial fin, in accordance with some examples;

FIG. 9 illustrates a method that can be used to correlate cell analyzer measurements with mass spectrometer measurements, in accordance with some examples;

FIG. 10 illustrates a method that can be used to determine cell uptake of an metal based agent, in accordance with some embodiments;

FIG. 11 is an illustration of a system comprising a flow loop configured to introduce sample into a cell analyzer, in accordance with some examples;

FIG. 12 is a graph showing correlation of cell size and metal mass in individual cells, in accordance with some examples;

FIG. 13 is another graph showing correlation of cell size and metal mass in individual cells, in accordance with some examples;

FIG. 14A is a graph showing correlation of live cells and metal mass in individual live cells, in accordance with some examples;

FIG. 14B is a graph showing correlation of live cells/dead cells and metal mass in the individual cells, in accordance with some examples; and

FIG. 15 is a graph showing correlation of different fluorescent markers with metal mass in individual cells, in accordance with certain embodiments.

It will be recognized by the skilled person in the art, given the benefit of this disclosure, that the components shown in the figures are provided merely for illustration purposes. Other components may also be present and the components of the figures may also be rearranged as desired. Any data shown in the figures is provided merely for illustration and is not intended to represent all possible data representations or relationships between cell response/phenotype and the amount of a particular element or metal within a cell.

### DETAILED DESCRIPTION

While various configurations below refer to the use of flow cytometry and mass spectrometry coupled to each other, other techniques and systems can also be used in place of, or with, a flow cytometer or a mass spectrometer. For example, a flow cytometer could be replaced with a fluorescent activated cell sorter, magnetic cell sorter, cell sorters which differentiate cells based on size or other devices that can differentiate between cells having different phenotypes or different properties. Each of the differentiated cells can then be provided to a mass spectrometer to detect and/or quantify a level of one or more materials in each of the individual cells. In some embodiments, one or more elemental species within each of the cells can be detected and/or quantified. The amount of the elemental species in each cell and the particular phenotype of the cell(s) can be correlated to provide useful information such as, for example, a level of uptake in each cell of an agent comprising the elemental species.

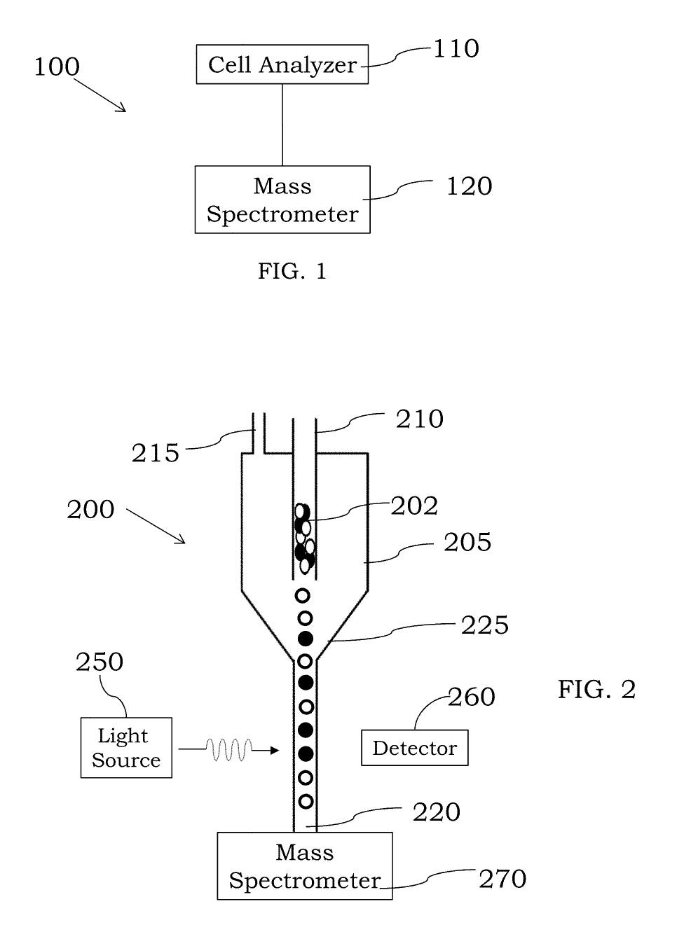

In certain embodiments and referring to FIG. 1, a block diagram of a system 100 comprising a cell analyzer 110 fluidically coupled to a mass spectrometer 120 is shown. Cells which are introduced into the cell analyzer 110 can be distinguished from each other on the basis of one or more physical or chemical properties. For example, protein molecules on the surfaces of the cells can be used to specifically bind to one or more agents that may comprise a label. The label can be detected to distinguish which cells comprise the surface protein versus which cells lack the surface protein. As each cell is detected and/or counted using the cell analyzer 110, the individual cells can then be provided to the mass spectrometer 120 where the elemental content, e.g., one, two, three, four or more elemental species can be detected, of the individual cell may then be measured. The phenotype of each cell can then be correlated with the measured elemental content.

In some examples, the cell analyzer 110 can be configured as a flow cytometer. A simple illustration of a flow cytometer is shown in FIG. 2. The flow cytometer comprises a flow cell 205 comprising a sample inlet 210, an inlet 215 for a sheath fluid and an outlet 220. As a cell suspension 202 enters into the flow cell 205 through the sample inlet 210 the cells become hydrodynamically focused at a nozzle area 225 as the sheath fluid is introduced into the inlet 215. This cell focusing causes each individual cell to be carried down the flow cell 205 where each cell may then be exposed to light from a light source 250. Where the cell suspension is labeled with a light emitting label, the label may emit or scatter light which can be detected by a detector 260 that is optically coupled to the light source 250. Where light is scattered, forward and side scattered light can be detected depending on the type and position of the detector 260. In some examples, two or more detectors may be present so both forward and side scattered light may be measured. For example, forward scattered light can be detected by positioning the detector in front of the light beam, and side scattered light can be detected by positioning one or more detectors to the side of the flow cell 205. As each cell flows through the flow cytometer, one or more cellular properties can be measured and each cell can be addressed or counted so that once the addressed cell is provided to a downstream mass spectrometer, the elemental species measured in the addressed cell can be correlated with the particular phenotype or cellular property measured by the flow cytometer.

In some examples, the cells can be introduced in to the cell analyzer using a syringe, autosampler or other devices. A linear flow of cells may be provided into the cell analyzer by configuring the cell analyzer with a flow loop or other suitable structures. The cells may be introduced from a syringe, microtiter plate, test tube, vessel or other devices which may be used to retain cells at least for some period.

In some examples, a cell population can be labeled with one or more labels specific for a particular cell characteristic. For example, the cell may express a specific protein on its cell surface. An antibody or other agent that can specifically bind to the cell characteristic may comprise a label which can be measured using the flow cytometer. In some examples, the antibody may comprise a fluorescent label whose emission can be detected using the flow cytometer. In certain instances, a cell population may be mixed with or incubated with the labeled antibody in a cell suspension to permit the labeled antibody to bind to the cells of the cell population. Excess label can be removed by centrifugation (or other techniques), and the cell population can then be provided to the flow cytometer to determine whether each measured cell comprises the labeled antibody or not. Various types of antibodies, labels and cells which can be used in the systems and methods described herein are discussed in more detail below.

In some examples, the cell analyzer can be configured as a fluorescent activated cell sorter (FACS). FACS can separate a cell suspension into two sub-populations based on fluorescent labeling. For example, cells labeled with a fluorophore conjugated antibody can be sorted from cells lacking the fluorophore conjugated antibody or from cells comprising a different fluorophore conjugated antibody. Each cell can be detected using a light source similar to that shown in the flow cytometer of FIG. 2. Referring to FIG. 3, as the individual cells exit the flow cell through an outlet 310, they may be provided to a deflector device 320 in the form of an electronically charged droplet (not shown). The charge imparted to the droplet can depend on the detected fluorescence. A deflector device 320 can attract or repel the charged cell droplet and direct the droplet into one of the channels. The sorted cell can then be provided into one of the mass spectrometers 330, 340 to detect one or more elemental species within the individual cells.

In some examples, magnetic cell sorting could be used in place of FACS. In magnetic cell sorting, one or more epitopes of the cell may bind specifically to an antibody labeled with a magnetic label, e.g., a magnetic nanoparticle label. The deflector device 320 in FIG. 3 can be replaced with a device configured to provide a magnetic field. Cells which comprise the magnetically labeled antibody can remain in the magnetic field while cells which lack the magnetically labeled antibody pass through the magnetic field. The cells which remain in the magnetic field can be provided to a separate vessel, and the elemental content of these cells can be determined using mass spectroscopy. As the non-magnetically labeled cells pass through the magnetic field, they can be individually provided to a mass spectrometer to determine the elemental content of these cells. If desired, a magnetic label can be used to remove cells which are not of interest, i.e., using negative selection, while cells of interest pass through the magnetic field and can be provided to a downstream mass spectrometer. In some examples, the magnetically labeled antibody may be specific for a fluorophore which is present on a different antibody. The magnetically labeled antibody can form a complex with the antibody comprising the fluorophore to permit the use of either FACS or magnetic cell sorting or both. Alternatively, specifically labeled fluorescent antibodies can be produced and a general antibody which binds to the fluorophore can be used where magnetically labeled antibodies for a specific epitope are not available or easily produced. General methods of producing fluorescently labeled and magnetically labeled antibodies are discussed in more detail below.

In other embodiments, the agent or material to be taken up by the cell may comprise one or more radioactive isotopes that can be measured indirectly using the cell analyzer, e.g., using scintillation counting, and be measured directly using the mass spectrometer. Illustrative radioisotopes are described in more detail below.

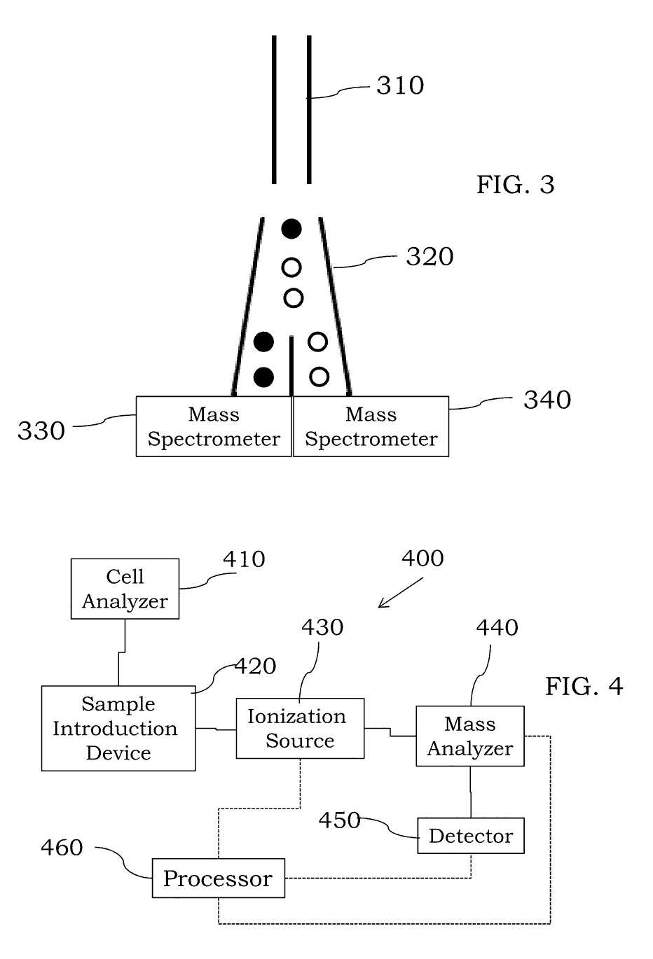

In certain examples, the mass spectrometers which are hyphenated to the cell analyzers may take many different forms. A general illustration of a mass spectrometer system hyphenated to a cell analyzer is shown in FIG. 4. The system 400 comprises a cell analyzer 410 fluidically coupled to a sample introduction device 420. The sample introduction device 420 is fluidically coupled to an ionization source 430. The ionization source 430 is fluidically coupled to a mass analyzer 440. The mass analyzer is fluidically coupled to a detector 450, which can be integral or separate from the mass analyzer 440. A processor 460 can be electrically coupled to one or more components of the system 400 to control the various sub-systems. In some examples, the sample introduction device 410 can be omitted and cells may be provided directly from the cell analyzer 410 into the ionization source 430.

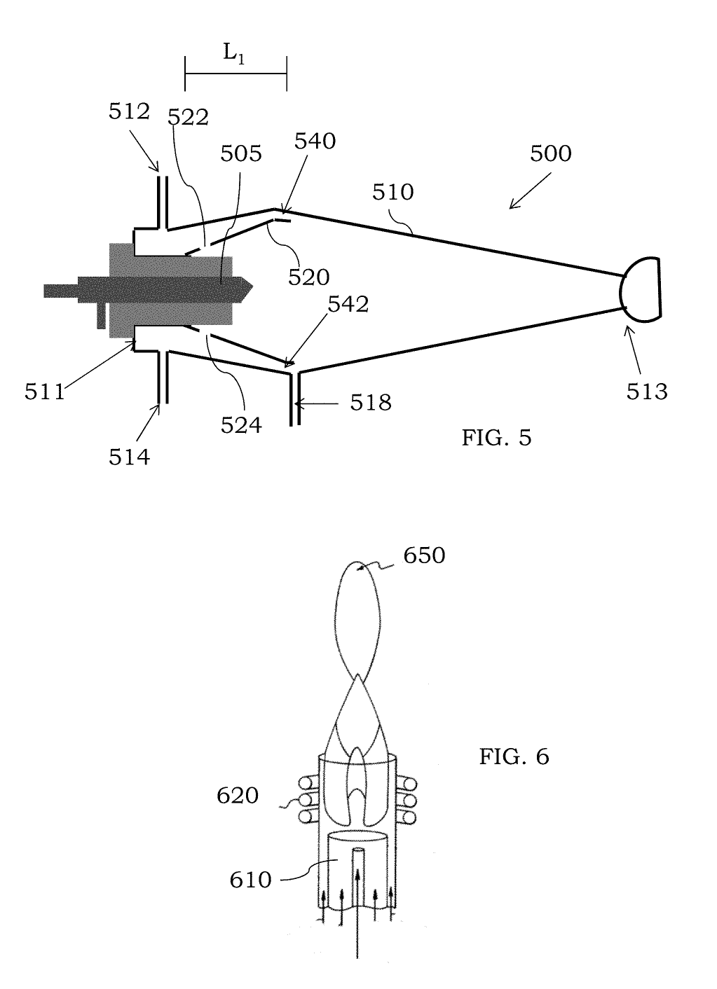

In configurations where a sample introduction device is present, the sample introduction device may be a nebulizer, aerosolizer, spray nozzle or head or other devices which can provide the cells to the ionization source 430. In some embodiments, the sample introduction device can be configured as a spray chamber as shown in FIG. 5. The spray chamber 500 generally comprises an outer chamber or tube 510 and an inner chamber or tube 520. The outer chamber 510 comprises dual makeup gas inlets 512, 514 and a drain 518. The makeup gas inlets 512, 514 are typically fluidically coupled to a common gas source, though different gases could be used if desired. While not required, the makeup gas inlets 512, 514 are shown as being positioned adjacent to an inlet end 511, though they could instead be positioned centrally or toward an outlet end 513. The inner chamber or tube 520 is positioned adjacent to a nebulizer tip 505 and may comprise two or more microchannels 522, 524 configured to provide a makeup gas flow to reduce or prevent cells from back flowing and/or depositing on the inner chamber or tube 520. The configuration and positioning of the inner chamber or tube 520 provides laminar flow at areas 540, 542 which acts to shield inner surfaces of the outer chamber 510 from any droplet deposition. The tangential gas flow provided by way of gas introduction into the spray chamber 500 through the inlets 512, 514 can acts to select cells of a certain size range. The microchannels 522, 524 in the inner chamber or tube 520 also are designed to permit the gas flows from the makeup gas inlets 512, 514 to shield the surfaces of the inner chamber or tube 520 from cell droplet deposition. In certain examples, the microchannels 522, 524 can be configured in a similar manner, e.g., have the same size and/or diameter, whereas in other configurations the microchannels 522, 524 may be sized or arranged differently. In some instances, at least two, three, four, five or more separate microchannels can be present in the inner chamber or tube 520. The exact size, form and shape of the microchannels may vary and each microchannel need not have the same size, form or shape. In some examples, different diameter microchannels may exist at different radial planes along a longitudinal axis L1 of the inner tube to provide a desired shielding effect. Illustrative spray chambers are described, for example, in U.S. application Ser. No. 15/597,608 filed on May 17, 2017, the entire disclosure of which is hereby incorporated herein by reference for all purposes.

In certain embodiments, the exact dimensions of the spray chamber 500 may vary. In certain configurations, a longitudinal length from the nebulizer tip 505 to the end of the spray chamber 500 may be about 10 cm to about 15 cm, e.g., about 12 or 13 cm. The diameter of the outer tube 510 may vary from about 1 cm to about 5 cm, e.g., about 3 cm or 4 cm. The largest diameter of the inner tube 520 may vary from about 0.5 cm to about 4 cm, and the distance between outer surfaces of the inner tube 520 and inner surfaces of the outer tube 510 can be selected to provide a desired laminar flow rate, e.g., the distance may be about 0.1 cm to about 0.75 cm. In certain examples, the inner tube 520 is shown as having a generally increasing internal diameter along the longitudinal axis of the outer chamber 510, but this dimensional change is not required. Some portion of the inner tube 510 may be “flat” or generally parallel with the longitudinal axis L1 to enhance the laminar flow, or in an alternative configuration, some portion of the inner tube 520 may generally be parallel to the surface of the outer tube 510, at least for some length, to enhance laminar flow. The inner diameter of the outer chamber increases from the inlet end 511 toward the outlet end 513 up to a point and then decreases toward the outlet end 513 such that the inner diameter of the outer chamber 510 is smaller at the outlet end 513 than at the inlet end 511. If desired, the inner diameter of the outer chamber 510 may remain constant from the inlet end 511 toward the outlet end 513 or may increase from the inlet end 511 toward the outlet end 513. If desired, two or more different spray chambers which are the same or different can be fluidically coupled to each other to assist in selection of individual cells.

In certain configurations, the ionization source 430 may take many different forms and is generally configured to ionize the elemental species present in each individual cell. In some examples, the ionization source may be a high temperature ionization source, e.g., one with an average temperature of about 4000 Kelvin or more, such as, for example, a direct current plasma, an inductively coupled plasma, an arc, a spark or other high temperature ionization sources. The exact ionization source used may vary depending on the particular elements and/or cells to be analyzed, and illustrative ionization sources include those which can atomize and/or ionize the elemental species to be detected, e.g., those ionization sources which can atomize and/or ionize metals, metalloids and other inorganic species or organic species. In other examples, the ionization source may comprise an electron impact source, a chemical ionization source, a field ionization source, desorption sources such as, for example, those sources configured for fast atom bombardment, field desorption, laser desorption, plasma desorption, thermal desorption, electrohydrodynamic ionization/desorption, etc., thermospray or electrospray ionization sources or other types of ionization sources.

In certain examples, the ionization source may comprise one or more torches and one or more induction devices. Certain components of an ionization source are shown in FIGS. 6-8. Illustrative induction devices and torches are described, for example, in U.S. Pat. Nos. 9,433,073 and 9,360,403, the entire disclosure of which is hereby incorporated herein by reference for all purposes. Referring to FIG. 6, a device comprising a torch 610 in combination with an induction coil 620 is shown. The induction coil 620 is typically electrically coupled to a radio frequency generator (not shown) to provide radio frequency energy into the torch 610 and sustain an inductively coupled plasma 650 within some portion of the torch 610. A sample introduction device (not shown) can be used to introduce individual cells into the plasma 650 to ionize and/or atomize the elemental species present in the individual cell. The ionized and/or atomized elemental species may be detected within the torch using axial or radial detection or can be provided to a downstream chamber or other device, e.g., a mass analyzer, for detection or further selection and/or filtering.

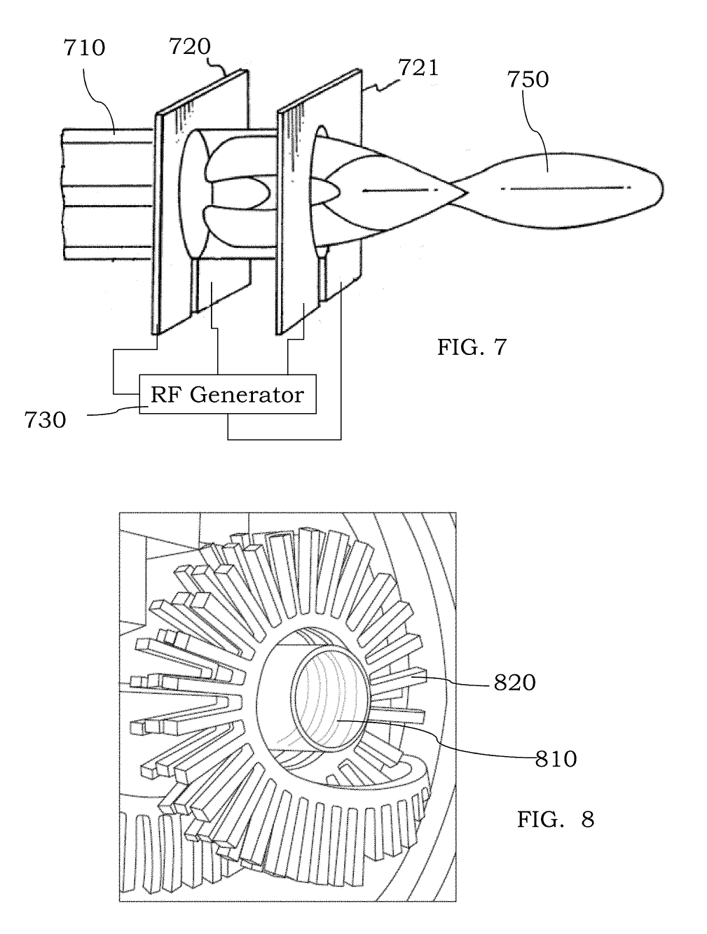

In an alternative configuration, the induction coil 620 in FIG. 6 could be replaced with one or more plate electrodes. For example and referring to FIG. 7, a first plate electrode 720 and a second plate electrode 721 are shown as comprising an aperture that can receive a torch 710. For example, the torch 710 can be placed within some region of an induction device comprising plate electrodes 720, 721. A plasma or other ionization/atomization source 750 such as, for example, an inductively coupled plasma can be sustained using the torch 710 and inductive energy from the plates 720, 721. A radio frequency generator 730 is electrically coupled to each of the plates 720, 721. If desired, only a single plate electrode could be used instead. A sample introduction device can be used to introduce individual cells into the plasma 750 to ionize and/or atomize species in the cell. Illustrative radio frequency generators are described, for example in U.S. Pat. Nos. 4,629,940, 6,329,757, and 9,420,679.

In other configurations, an induction device comprising one or more radial fins could instead be used in methods and systems described herein. Referring to FIG. 8, a device or system may comprise an induction coil 820 comprising at least one radial fin and a torch 810. A plasma or other ionization/atomization source (not shown) such as, for example, an inductively coupled plasma can be sustained using the torch 810 and inductive energy from the radially finned induction device 820. A radio frequency generator (not shown) can be electrically coupled to the induction device 820 to provide radio frequency energy into the torch 810. A sample introduction device (not shown) can be used to introduce individual cells into the torch 810. Elemental species in the introduced individual cell can be ionized or atomized and separated using the downstream mass analyzer. In other instances, one or more capacitive device such as, for example, capacitive coils or capacitive plates can be used in an ionization source. Further two or more induction devices, capacitive devices or other devices which can provide energy into the torch to sustain an atomization/ionization source such as a plasma can also be used.

In certain examples, the mass analyzer 440 can take numerous forms depending generally on the sample nature, desired resolution, etc. and exemplary mass analyzers are discussed further below. The detector 450 can be any suitable detection device that can be used with existing mass spectrometers, e.g., electron multipliers, Faraday cups, coated photographic plates, scintillation detectors, etc. and other suitable devices that will be selected by the person of ordinary skill in the art, given the benefit of this disclosure. The processor 460 typically includes a microprocessor and/or computer and suitable software for analysis of samples introduced into the system 400. If desired, one or more databases can be accessed by the processor 460 for determination of the chemical identity of species introduced into the system 400.

In certain embodiments, the mass analyzer 440 can take numerous forms depending on the desired resolution and the nature of the introduced sample. In certain examples, the mass analyzer is a scanning mass analyzer, a magnetic sector analyzer (e.g., for use in single and double-focusing MS devices), a quadrupole mass analyzer, an ion trap analyzer (e.g., cyclotrons, quadrupole ions traps), time-of-flight analyzers, and other suitable mass analyzers that can separate or filter (or both) elemental species with different mass-to-charge ratios. The mass analyzer may comprise two or more different devices arranged in series, e.g., tandem MS/MS devices or triple quadrupole devices, to select and/or identify the ions that are received from the ionization source 430.

In certain examples, the cell analyzer 410 is configured to determine cell size and the processor 460 is configured to correlate the determined cell size of the individual cell with the determined amount of the first element present in the individual cell. The cell size may be determined, for example, by measuring the forward light scattering of the cell using flow cytometry. The nature and/or amount of the first element can be determined using the mass analyzer 440 and detector 450. The processor 460 can then correlate each size measurement from the cell analyzer 410 with the element measurements from the detector 450.

In some embodiments, the cell analyzer 410 is configured to determine cell viability and the processor 460 is configured to correlate the determined cell viability of the individual cell with the determined amount of the first element present in the individual cell. Cell viability may be determined, for example, by measuring levels of propidium iodide in the cells. Propidium iodide is generally excluded in live cells but may be taken up by dead cells. Other materials and dyes may also be used to differentiate between live and dead cells.

In other embodiments, the cell analyzer 410 is configured to determine cell phenotype and the processor 460 is configured to correlate the determined cell phenotype of the individual cell with the determined amount of the first element present in the individual cell. As noted herein, the cell phenotype can be determined using labeled antibodies which are specific for one or more antigens present in the cells.

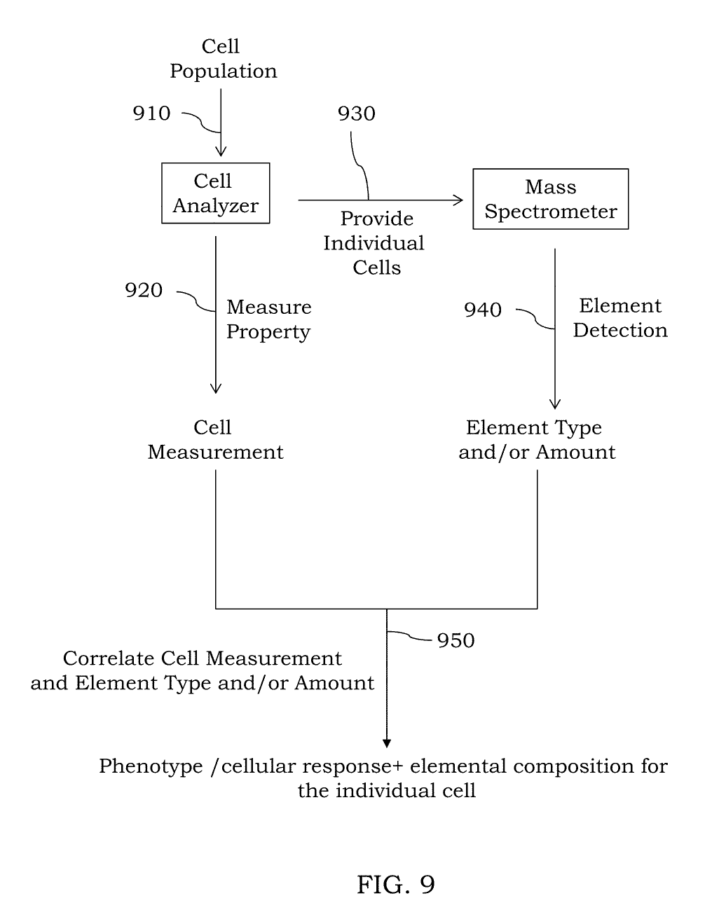

In certain embodiments, the systems described herein can be used to correlate an individual cell phenotype with a determined amount of a first element in the individual cell. Referring to FIG. 9, a cell population can be provided to a cell analyzer at a step 910. The cell analyzer can be configured to measure one or more physical or chemical properties at a step 920. Individual cells from the cell analyzer can then be provided to a mass spectrometer at a step 930. The mass spectrometer can determine a type and/or amount of one or more elements at a step 940. The measured cell property can then be correlated with the measured amount of the at least one element at a step 950. For example, the phenotype of the cell and the amount of a particular element in that cell can be correlated with each other. The methodology shown in FIG. 9 can be repeated for each cell in a cell population to permit correlation of the quantified amount of the first element in each of the cells with the individual cell measurements from the cell analyzer. Because all cells of a cell population can be measured, the method can be used to determine a number or percentage of the cells in the cell population that comprise a first element or material. Alternatively, the quantified amount of the first element or material in each of the cells and the individual cell measurements from the cell analyzer can be used to determine a number of the cells in the cell population that exhibit a selected biological response, e.g., display a certain antigen on the cell surface. In some examples, the cell analyzer can be used to determine a size of each cell of the cell population, and the measured amount of a first element or material in each of the cells can then be correlated with the cell size measurements.

While the methods refer to determination of a first element (or other material) in the individual cell, the same methodology can be used to determine a level of a second, third, fourth or more elements (or other materials) in each cell. In some examples, the type and amount of two different elements present in a cell can simultaneously be determined as described in commonly owned application filed on Jan. 8, 2018 and bearing serial number U.S. 62/614,888 and entitled “Methods and Systems for Quantifying Two or More Analytes Using Mass Spectrometry.”

In certain embodiments, the methods described herein may desirably use a unicellular suspension of cells to increase the likelihood that an individual cell is provided to the cell analyzer and/or mass spectrometer. The unicellular suspension may comprise homogeneous or heterogeneous cell population and may comprise the same or different types of cells. Illustrative types of cells are discussed in more detail below and include both prokaryotic and eukaryotic cells. Many different cells types and sizes can be used, and illustrative cell sizes may vary from about 0.2 microns to about 100 microns, e.g., an average diameter of the cell may be from about 0.2 microns to about 100 microns. Cells which are larger or smaller may also be used. Further, cellular organelles can be isolated and introduced into the systems described herein. The cells and cell population can be subjected to one or more preparation steps including chromatography, electrophoresis, cell sizing, cell expression, labeling, incubation, staining or other steps may be performed prior to introducing the cells into the cell analyzer. As noted herein, a label is often used in combination with an agent that specifically binds to a site on the cell. The cells can also be subjected to one or more dyes or agents to assist in distinguishing cell size or live cells versus dead cells.

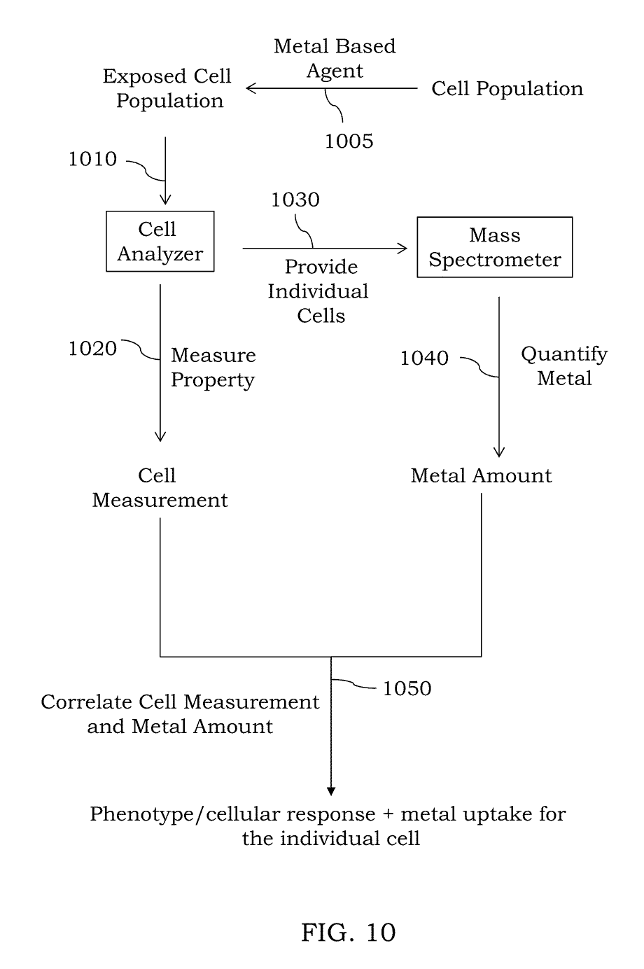

In some examples, the methods described herein can be used to determine or measure uptake of an agent into cells. For example, uptake of a first metal agent can be determined by measuring the levels of the first metal in each of the cells. In some examples, the method comprises exposing a cell population to the first metal agent, determining a phenotype of individuals cells in the cell population using a cell analyzer, providing individual cells from the cell analyzer to a mass spectrometer fluidically coupled to the cell analyzer to quantify an amount of the first metal agent taken into each of the provided individual cells, and correlating the quantified amount of the first metal agent taken into each of the individual cells with the determined phenotype of each of the individual cells. An illustration of the process is shown in FIG. 10. A cell population is exposed to the metal based agent at a step 1005. Free metal based agent may be removed from the cell by centrifugation, filtering or other steps. The exposed cell population can then be provided to a cell analyzer at a step 1010. The cell analyzer may perform one or more measurements at a step 1020, e.g., determine cell size, cell status such as alive or dead, etc. Individual cells are then provided to a mass spectrometer at a step 1030 to quantify how much of the metal based agent was taken up by the cells at a step 1040. The measured property from the cell analyzer can then be correlated with the determined amount of the metal from the mass spectrometer. While a metal based agent is described for illustration purposes, metalloids or elements other than metals could instead be present in the agent and used as an indicator of how much of the agent was taken up by the cells.

In certain examples, the metal agent may comprise an elemental species with an atomic mass from 2 atomic mass units (amu's) to 258 amu's. In other instances, the first metal agent may comprise one or more transition metals or one or more metalloids. The metal or element selected for use may be intentionally selected to be a transition metal agent that is effective as a DNA replication inhibitor, e.g., cis-platin or other similar metal containing agents. In some embodiments, an amount of cells of the cell population that are resistant to uptake of the agent can be determined using the quantified amount of the agent in the individual cells and the determined phenotype of each of the individual cells of the cell population.

In some embodiments, the cells can be exposed to a second metal agent, wherein the second metal agent comprises a different metal than the first metal agent. Such exposure to the two agents may occur sequentially or simultaneously. A phenotype of individuals cells in the cell population exposed to the second metal agent can be determined using a cell analyzer. Individual cells from the cell analyzer can be provided to a mass spectrometer fluidically coupled to the cell analyzer to quantify an amount of the second metal agent taken into each of the provided individual cells. The quantified amount of the second metal agent taken into each of the individual cells can be correlated with the determined phenotype of each of the individual cells. In certain embodiments, an amount of cells of the cell population that are resistant to uptake of the second metal agent can be determined using the quantified amount of the second metal agent in the individual cells and using the determined phenotype of each of the individual cells of the cell population. The cell analyzer of FIGS. 9 and 10 may be a flow cytometer, a fluorescence activated cell sorter, a magnetic sorter or other suitable cell analyzers. While not shown, the cells can be exposed to a labeled antibody or other material which can specifically bind to one or more sites on the cells.

In certain examples and as noted above, the systems and methods described herein may comprise or use a processor to control some aspects of the systems or processes. The processor can be part of the system or instrument or present in an associated device, e.g., computer, laptop, mobile device, etc. used with the instrument. For example, the processor can be used to control the provided voltages to the mass analyzer, introduction of a sheath fluid into the cell analyzer, and/or can be used by the detector. Such processes may be performed automatically by the processor without the need for user intervention or a user may enter parameters through user interface. For example, the processor can use signal intensities and fragment peaks along with one or more calibration curves to determine an identity and how much of a particular element is present in each individual cell. In certain configurations, the processor may be present in one or more computer systems and/or common hardware circuity including, for example, a microprocessor and/or suitable software for operating the system, e.g., to control the sample introduction device, ionization source, mass analyzer, detector, etc. In some examples, the detector itself may comprise its own respective processor, operating system and other features to permit detection of various molecules. The processor can be integral to the systems or may be present on one or more accessory boards, printed circuit boards or computers electrically coupled to the components of the system. The processor is typically electrically coupled to one or more memory units to receive data from the other components of the system and permit adjustment of the various system parameters as needed or desired. The processor may be part of a general-purpose computer such as those based on Unix, Intel PENTIUM-type processor, Motorola PowerPC, Sun UltraSPARC, Hewlett-Packard PA-RISC processors, or any other type of processor. One or more of any type computer system may be used according to various embodiments of the technology. Further, the system may be connected to a single computer or may be distributed among a plurality of computers attached by a communications network. It should be appreciated that other functions, including network communication, can be performed and the technology is not limited to having any particular function or set of functions. Various aspects may be implemented as specialized software executing in a general-purpose computer system. The computer system may include a processor connected to one or more memory devices, such as a disk drive, memory, or other device for storing data. Memory is typically used for storing programs, calibration curves, chemical or physical properties measured by the cell analyzer, and data values during operation of the systems. Components of the computer system may be coupled by an interconnection device, which may include one or more buses (e.g., between components that are integrated within a same machine) and/or a network (e.g., between components that reside on separate discrete machines). The interconnection device provides for communications (e.g., signals, data, instructions) to be exchanged between components of the system. The computer system typically can receive and/or issue commands within a processing time, e.g., a few milliseconds, a few microseconds or less, to permit rapid control of the system. For example, computer control can be implemented to control sample introduction, flow rates, voltages provided to components of the mass analyzer, detector parameters, etc. The processor typically is electrically coupled to a power source which can, for example, be a direct current source, an alternating current source, a battery, a fuel cell or other power sources or combinations of power sources. The power source can be shared by the other components of the system. The system may also include one or more input devices, for example, a keyboard, mouse, trackball, microphone, touch screen, manual switch (e.g., override switch) and one or more output devices, for example, a printing device, display screen, speaker. In addition, the system may contain one or more communication interfaces that connect the computer system to a communication network (in addition or as an alternative to the interconnection device). The system may also include suitable circuitry to convert signals received from the various electrical devices present in the systems. Such circuitry can be present on a printed circuit board or may be present on a separate board or device that is electrically coupled to the printed circuit board through a suitable interface, e.g., a serial ATA interface, ISA interface, PCI interface or the like or through one or more wireless interfaces, e.g., Bluetooth, Wi-Fi, Near Field Communication or other wireless protocols and/or interfaces.

In certain embodiments, the storage system used in the systems described herein typically includes a computer readable and writeable nonvolatile recording medium in which codes of software can be stored that can be used by a program to be executed by the processor or information stored on or in the medium to be processed by the program. The medium may, for example, be a hard disk, solid state drive or flash memory. The program or instructions to be executed by the processor may be located locally or remotely and can be retrieved by the processor by way of an interconnection mechanism, a communication network or other means as desired. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or storage system. In certain embodiments, the system may also include specially-programmed, special-purpose hardware, for example, an application-specific integrated circuit (ASIC) or a field programmable gate array (FPGA). Aspects of the technology may be implemented in software, hardware or firmware, or any combination thereof. Further, such methods, acts, systems, system elements and components thereof may be implemented as part of the systems described above or as an independent component. Although specific systems are described by way of example as one type of system upon which various aspects of the technology may be practiced, it should be appreciated that aspects are not limited to being implemented on the described system. Various aspects may be practiced on one or more systems having a different architecture or components. The system may comprise a general-purpose computer system that is programmable using a high-level computer programming language. The systems may be also implemented using specially programmed, special purpose hardware.

In the systems, the processor is typically a commercially available processor such as the well-known Pentium class processors available from the Intel Corporation. Many other processors are also commercially available. Such a processor usually executes an operating system which may be, for example, the Windows 95, Windows 98, Windows NT, Windows 2000 (Windows ME), Windows XP, Windows Vista, Windows 7, Windows 8 or Windows 10 operating systems available from the Microsoft Corporation, MAC OS X, e.g., Snow Leopard, Lion, Mountain Lion or other versions available from Apple, the Solaris operating system available from Sun Microsystems, or UNIX or Linux operating systems available from various sources. Many other operating systems may be used, and in certain embodiments a simple set of commands or instructions may function as the operating system. Further, the processor can be designed as a quantum processor designed to perform one or more functions using one or more qubits.

In certain examples, the processor and operating system may together define a platform for which application programs in high-level programming languages may be written. It should be understood that the technology is not limited to a particular system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate systems could also be used. In certain examples, the hardware or software can be configured to implement cognitive architecture, neural networks or other suitable implementations. If desired, one or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. Various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

In some instances, various embodiments may be programmed using an object-oriented programming language, such as, for example, SQL, SmallTalk, Basic, Java, Javascript, PHP, C++, Ada, Python, iOS/Swift, Ruby on Rails or C# (C-Sharp). Other object-oriented programming languages may also be used. Alternatively, functional, scripting, and/or logical programming languages may be used. Various configurations may be implemented in a non-programmed environment (e.g., documents created in HTML, XML or other format that, when viewed in a window of a browser program, render aspects of a graphical-user interface (GUI) or perform other functions). Certain configurations may be implemented as programmed or non-programmed elements, or any combination thereof. In some instances, the systems may comprise a remote interface such as those present on a mobile device, tablet, laptop computer or other portable devices which can communicate through a wired or wireless interface and permit operation of the systems remotely as desired.

In certain examples, the processor may also comprise or have access to a database of information about elemental species, which can include atomic mass, mass-to-charge ratios and other common information. The instructions stored in the memory can execute a software module or control routine for the system, which in effect can provide a controllable model of the system. The processor can use information accessed from the database together with one or software modules executed in the processor to determine control parameters or values for different components of the systems, e.g., different cell analyzer parameters, different mass analyzer parameters, etc. Using input interfaces to receive control instructions and output interfaces linked to different system components in the system, the processor can perform active control over the system. For example, the processor can control the detector, sample introduction devices, ionization sources, cell analyzer, mass analyzer and other components of the system.

In certain embodiments, the exact cell type that can be used with the systems and methods described herein may vary. In some examples, the cells may be prokaryotic cells. For example, drug discovery methods using metal based antibiotics may be implemented to determine how much of a particular metal based antibiotic is taken up by the individual bacterial cells and to determine the phenotype of the cells, e.g., alive or dead, to assess the efficacy of a particular metal based drug candidate. Where the cell is a bacterial cell, the bacterial cell may be a cell from one or more of the Acidobacteria, Actinobacteria, Aquificae, Armatimonadetes, Bacteroidetes, Caldiserica, Chlamydiae, Chlorobi, Chloroflexi, Chrysiogenetes, Cyanobacteria, Deferribacteres, Deinococcus-Thermus, Dictyoglomi, Elusimicrobia, Fibrobacteres, Firmicutes, Fusobacteria, Gemmatimonadetes, Lentisphaerae, Nitrospirae, Planctomycetes, Proteobacteria, Spirochaetes, Synergistetes, Tenericutes, Thermodesulfobacteria, Thermotogae or Verrucomicrobia phyla. Illustrative classes, orders and/or families of bacterial cells that can be analyzed include, but are not limited to, those from Acidobacteria, Blastocatellia, Holophagae, Rubrobacteria, Thermoleophilia, Coriobacteriia, Acidimicrobiia, Nitriliruptoria, Actinobacteria, Aquificales, Aquificaceae, Hydrogenothermaceae, Desulfurobacteriales, Desulfurobacteriaceae, Thermosulfidibacter, Fimbriimonadia, Armatimonadia, Chthonomonadetes, Rhodothermia, Rhodothermales, Balneolia, Balneolales, Cytophagia, Cytophagales, Sphingobacteria, Sphingobacteriales, Chitinophagia, Chitinophagales, Bacteroidia, Bacteroidales, Flavobacteriia, Flavobacteriales, Caldisericaceae, Chlamydiales, Chlamydiaceae, Candidatus, Clavichlamydiaceae, Parachlamydiales, Criblamydiaceae, Parachlamydiaceae, Simkaniaceae, Waddliaceae, Candidatus Piscichlamydia, Candidatus Actinochlamydiaceae, Candidatus Parilichlamydiaceae, Candidatus Rhabdochlamydiaceae, Ignavibacteria, Ignavibacteriales, Ignavibacteriaceae, Ignavibacterium, Melioribacter, Chlorobea, Chlorobiales, Chlorobiaceae, Ancalochloris, Chlorobaculum, Chlorobium, Chloroherpeton, Clathrochloris, Pelodictyon, Prosthecochloris, Thermoflexia, Dehalococcoidia, Anaerolineae, Ardenticatenia, Caldilineae, Ktedonobacteria, Thermomicrobia, Chloroflexia, Chrysiogenetes, Chrysiogenales, Chrysiogenaceae, Chroococcales, Chroococcidiopsidales, Gloeobacterales, Nostocales, Oscillatoriales, Pleurocapsales, Spirulinales, Synechococcales, Incertae sedis, Deferribacterale, Deferribacteraceae, Deinococcales, Deinococcaceae, Trueperaceae, Thermales, Thermaceae, Dictyoglomales, Dictyoglomaceae, Elusimicrobia, Endomicrobia, Blastocatellia, Chitinispirillia, Chitinivibrionia, Fibrobacteria, Bacilli, Bacillales, Lactobacillales,Clostridia, Clostridiales, Halanaerobiales, Natranaerobiales, Thermoanaerobacterales, Erysipelotrichia, Erysipelotrichales, Negativicutes, Selenomonadales, Thermolithobacteria, Fusobacteriia, Fusobacteriales, Leptotrichiaceae, Sebaldella, Sneathia, Streptobacillus, Leptotrichia, Fusobacteriaceae, Cetobacterium, Fusobacterium, Ilyobacter, Propionigenium, Psychrilyobacter, Longimicrobia, Gemmatimonadetes, Oligosphaeria, Lentisphaeria, Nitrospiria, Nitrospirales, Nitrospiraceae, Phycisphaerae, Planctomycetacia, Alphaproteobacteria, Betaproteobacteria, Hydrogenophilalia, Gammaproteobacteria, Acidithiobacillia, Deltaproteobacteria, Epsilonproteobacteria and Oligoflexia, Spirochaetia, Brachyspirales, Brachyspiraceae, Brevinematales, Brevinemataceae, Leptospirales Leptospiraceae, Spirochaetales, Borreliaceae, Spirochaetaceae, Sarpulinaceae, Synergistia, Synergistales, Synergistaceae, Mollicutes, Thermodesulfobacteria, Thermodesulfobacteriales, Thermodesulfobacteriaceae, Thermotogae, Kosmotogales, Kosmotogaceae, Mesoaciditogales, Mesoaciditogaceae, Petrotogales, Petrotogaceae, Thermotogales, Thermotogaceae, Fervidobacteriaceae, Candidatus Epixenosoma, Lentimonas, Methyloacida, Methylacidimicrobium, Methylacidiphilales, Spartobacteria, Opitutae or Verrucomicrobiae. Various genera and species within these classes, orders and families can be selected for analysis using the methods and systems described herein.

In other embodiments, the cells may be eukaryotic cells including both “normal” eukaryotic cells which are present in properly functioning tissue and “aberrant” eukaryotic cells which are present in a cancerous or abnormal condition. In addition, the eukaryotic cells may originate from protozoa, fungus, animals, plants, algae or other eukaryotic cells. The methods and systems may be particularly desirable for use in investigating treatment of fungal infections, efficacy of cancer treatment, efficacy of pesticide treatment, tissue repair status and other states that can be monitored based on how much of a material is present within a cell.

Where the cell is a fungal cell, the fungal cell may be from one or more of Blastocladiomycota, Chytridiomycota, Glomeromycota, Microsporidia, Neocallimastigomycota, Dikarya (inc. Deuteromycota), Ascomycota, Pezizomycotina, Saccharomycotina, Taphrinomycotina, Basidiomycota Agaricomycotina, Pucciniomycotina, Ustilaginomycotina, Entomophthoromycotina, Kickxellomycotina, Mucoromycotina, or Zoopagomycotina phyla and subphyla. Illustrative classes, orders and/or families of fungal cells that can be analyzed include, but are not limited to, those from Blastocladiomycetes, Blastocladiales Blastocladiaceae, Catenariaceae, Coelomomycetaceae, Physodermataceae, Sorochytriaceae, Chytridiomycetes, Chytridiales, Cladochytriales, Rhizophydiales, Polychytriales, Spizellomycetales, Rhizophlyctidales, Lobulomycetales, Gromochytriales, Mesochytriales, Synchytriales, Polyphagales, Monoblepharidomycetes, Monoblepharidales, Harpochytriales, Hyaloraphidiomycetes, Hyaloraphidiales, Glomeromycetes, Archaeosporales, Diversisporales, Glomerales, Paraglomerales, Nematophytales, Metchnikovellea, Metchnikovellida Amphiacanthidae, Metchnikovellidae, Microsporea, Cougourdellidae, Facilisporidae, Heterovesiculidae, Myosporidae, Nadelsporidae, Neonosemoidiidae, Ordosporidae, Pseudonosematidae, Telomyxidae, Toxoglugeidae, Tubulinosematidae, Haplophasea, Chytridiopsida, Chytridiopsidae, Buxtehudiidae, Enterocytozoonidae, Burkeidae, Hesseidae, Glugeida, Glugeidae, Gurleyidae, Encephalitozoonidae, Abelsporidae, Tuzetiidae, Microfilidae, Unikaryonidae, Dihaplophasea, Meiodihaplophasida, Thelohanioidea, Thelohaniidae, Duboscqiidae, Janacekiidae, Pereziidae, Striatosporidae, Cylindrosporidae, Burenelloidea, Burenellidae, Amblyosporoidea, Amblyosporidae, Dissociodihaplophasida, Nosematoidea, Nosematidae, Ichthyosporidiidae, Caudosporidae, Pseudopleistophoridae, Mrazekiidae Culicosporoidea, Culicosporidae, Culicosporellidae, Golbergiidae, Spragueidae Ovavesiculoidea, Ovavesiculidae, Tetramicridae, Rudimicrospora, Minisporea, Minisporida, Metchnikovellea, Metchnikovellida, Polaroplasta, Pleistophoridea, Pleistophorida, Disporea, Unikaryotia, Diplokaryotia, Neocallimastigomycetes, Neocallimastigales, Neocallimastigaceae, Pezizomycotina, Arthoniomycetes, Coniocybomycetes, Dothideomycetes, Eurotiomycetes, Geoglossomycetes, Laboulbeniomycetes, Lecanoromycetes, Leotiomycetes, Lichinomycetes, Orbiliomycetes, Pezizomycetes, Sordariomycetes, Xylonomycetes Lahmiales, Itchiclahmadion, Triblidiales, Saccharomycotina, Saccharomycetes, Taphrinomycotina Archaeorhizomyces, Neolectomycetes, Pneumocystidomycetes, Schizosaccharomycetes, Taphrinomycetes, Arthoniomycetes, Coniocybomycetes, Dothideomycetes, Eurotiomycetes, Geoglossomycetes, Laboulbeniomycetes, Lecanoromycetes, Leotiomycetes, Lichinomycetes, Orbiliomycetes, Pezizomycetes, Sordariomycetes, Xylonomycetes, Lahmiales, Medeolariales, Triblidiales, Saccharomycetales, Ascoideaceae, Cephaloascaceae, Debaryomycetaceae, Dipodascaceae, Endomycetaceae, Lipomycetaceae, Metschnikowiaceae, Phaffomycetaceae, Pichiaceae, Saccharomycetaceae, Saccharomycodaceae, Saccharomycopsidaceae, Trichomonascaceae, Archaeorhizomycetes, Neolectomycetes, Pneumocystidomycetes, Schizosaccharomycetes, Taphrinomycetes, Agaricomycotina, Pucciniomycotina, Ustilaginomycotina, Wallemiomycetes, Tremellomycetes, Dacrymycetes, Agaricomycetes, Agaricostilbomycetes, Atractiellomycetes, Classiculomycetes, Cryptomycocolacomycetes, Cystobasidiomycetes, Microbotryomycetes, Mixiomycetes, Pucciniomycetes, Tritirachiomycetes, Exobasidiomycetes, Ceraceosorales, Doassansiales, Entylomatales, Exobasidiales, Georgefischeriales, Microstromatales, Tilletiales, Ustilaginomycetes, Urocystales, Ustilaginales, Malasseziomycetes, Malassezioales, Moniliellomycetes, Moniliellales, Basidiobolomycetes, Neozygitomycetes, Entomophthoromycetes, Asellariales, Dimargaritales, Harpellales, Kickxellales, Mortierellomycetes, Mortierellales, Mucoromycetes, Mucorales, or Endogonales. Various genera and species within these classes, orders and families can be selected for analysis using the methods and systems described herein.

Where the cell is a plant cell, the plant cell may be from one or more of Nematophytes, Chlorophyta, Palmophyllales, Prasinophyceae, Nephroselmidophyceae, Pseudoscourfieldiales, Pyramimonadophyceae, Mamiellophyceae, Scourfieldiales, Pedinophyceae, Chlorodendrophyceae, Trebouxiophyceae, Ulvophyceae, Chlorophyceae, Streptophyta, Chlorokybophyta, Mesostigmatophyta, Klebsormidiophyta, Charophyta, Chaetosphaeridiales, Coleochaetophyta, Zygnematophyta, or Embryophyta phyla and subphyla. Illustrative classes, orders, families and genera of plant cells that can be analyzed include, but are not limited to, those from Nematothallus, Cosmochlaina, Nematophytaceae, Nematoplexus, Nematasketum, Prototaxites, Ulvophyceae, Trebouxiophyceae, Chlorophyceae, Chlorodendrophyceae, Mamiellophyceae, Nephroselmidophyceae, Palmophyllales, Pedinophyceae, Prasinophyceae, Pseudoscourfieldiales, Pyramimonadophyceae, Scourfieldiales, Palmoclathrus, Palmophyllum, Verdigellas, Prasinococcales, Prasinophyceae incertae sedis, Pseudoscourfieldiales, Pyramimonadales, Nephoselmis, Pycnococcaceae, Scourfieldiaceae, Pedinomonas, Resultor, Marsupiomonas, Chlorochtridion tuberculatum, Chlorellales, Prasiolales, Trebouxiales, Bryopsidales, Cladophorales, Dasycladales, Oltmannsiellopsidales, Scotinosphaerales, Trentepohliales, Ulotrichales, Ulvales, Chaetopeltidales, Chaetophorales, Chlamydomonadales, Chlorococcales, Chlorocystidales, Microsporales, Oedogoniales, Phaeophilales, Sphaeropleales, Tetrasporales, Chlorokybus, Mesostigmatophyceae, Entransia, Hormidiella, Interfilum, Klebsormidium, Mesostigmatophyceae, Klebsormidiophyceae, Zygnematophyceae, ZygnematalesDesmidiales, Charophyceae, Charales, Chlorokybophyceae, Coleochaetales, Polychaetophora, Chaetosphaeridium, Coleochaetophyceae, Zygnematales, Desmidiales, Bryophytes, Marchantiophyta, Bryophyta, Anthocerotophyta, Horneophytopsida, Tracheophytes, Rhyniophyta, Zosterophyllophyta, Lycopodiophyta, Trimerophytophyta, Pteridophyta, Spermatophytes, Pteridospermatophyta, Pinophyta, Cycadophyta, Ginkgophyta, Gnetophyta, or Magnoliophyta. Various species within these classes, orders, families and genera can be selected for analysis using the methods and systems described herein.

In some examples, one or more analytes in a plant organelle can be quantified using the methods and systems described herein. For example, a plant organelle can include, but is not limited to, plant cell nucleus, nuclear membrane, a nuclear membrane, endoplasmic reticulum, ribosome, mitochondria, vacuole, chloroplast, cell membrane or cell wall. The plant organelle may be separated from the other material of the cell so the analytes of the isolated plant organelle can be quantified.

Where the cell is an animal cell, the animal cell may be an embryonic stem cell, an adult stem cell, a tissue-specific stem cell, a mesenchymal stem cell, an induced pluripotent stem cells, an epithelial tissue cell, a connective tissue cell, a muscle tissue cell, or a nervous tissue cell. The animal cell can be derived from ectoderm, endoderm or mesoderm. Ectoderm derived cells include, but are not limited to, skin cells, anterior pituitary cells, peripheral nervous system cells, neuroendocrine cells, teeth, eye cells, central nervous system cells, ependymal cells and pineal gland cells. Endoderm derived cells include, but are not limited to, respiratory cells, stomach cells, intestine cells, liver cells, gallbladder cells, exocrine pancreas cells, Islets of Langerhans cell, thyroid gland cells and urothelial cells. Mesoderm derived cells include, but are not limited to, osteochondroprogenitor cells, myofibroblast, angioblasts, stromal cells, Macula densa, cells, interstitial cells, telocytes, podocytes, Sertoli cells, Leydig cells, Granulosa cells, Peg cells, germ cells, hematopoietic stem cells, lymphoid cells, myeloid cells, endothelial progenitor cells, endothelial colony forming cells, endothelial stem cell, angioblast/mesoangioblast cells, pericyte cells and mural cells.

In some examples, the animal cell is typically a mammalian cell such as, for example, a human cell, a canine cell, an equine cell, a feline cell, a bovine cell, and other animal cells in one or more of the following mammalian orders Artiodactyla, Carnivora, Cetacea, Chiroptera, Dermoptera, Edentata, Hyracoidae, Insectivora, Lagomorpha, Morasupilia, Monotremata, Perissodactyla, Pholidata, Pinnipedia, Primates, Proboscidea, Rodentia, Sirenia, and Turbulidentata. In some examples, the mammalian cell may be from a Prosimian family or a Simian family. In other examples, the mammalian cell may be from one or more Adapiformes, Lemuriformes, Omomyiformes and Tarsiiformes. In additional examples, the mammalian cell may be from one or more Haplorhini's or Simiiformes. In some examples, the mammalian cell may be from the family Hominidae or the genus Homo, e.g., human cells.

In some instances, cancerous animal cells may also be analyzed using the methods and systems described herein to assess efficacy of treatment with a particular agent. While the exact agent may vary with the specific type of cancer to be treated, the agent desirably causes death of the cancer cells in some manner. Illustrative types of cancer whose cells can be analyzed include, but are not limited to, Acute Lymphoblastic Leukemia (ALL), Acute Myeloid Leukemia (AML), Adrenocortical Carcinoma, AIDS-Related Cancers Kaposi Sarcoma (Soft Tissue Sarcoma), AIDS-Related Lymphoma (Lymphoma), Primary CNS Lymphoma (Lymphoma), Anal Cancer, Appendix Cancer, Astrocytomas, Atypical Teratoid/Rhabdoid Tumors, Basal Cell Carcinoma of the Skin, Bile Duct Cancer, Bladder Cancer, Bone Cancer, Brain Tumors, Breast Cancer, Bronchial Tumors, Burkitt Lymphoma, Carcinoid Tumor, Carcinoma of Unknown Primary, Cardiac (Heart) Tumors, Atypical Teratoid/Rhabdoid Tumor, Embryonal Tumors, Germ Cell Tumor, Primary CNS Lymphoma, Cervical Cancer, Childhood Cancers, Cholangiocarcinoma, Chordoma, Chronic Lymphocytic Leukemia (CLL), Chronic Myelogenous Leukemia (CML), Chronic Myeloproliferative Neoplasms, Colorectal Cancer, Craniopharyngioma, Cutaneous T-Cell Lymphoma, ductal carcinoma, Endometrial Cancer, Uterine Cancer), Ependymoma, Esophageal Cancer, Esthesioneuroblastoma, Ewing Sarcoma, Extracranial Germ Cell Tumor, Extragonadal Germ Cell Tumor, Eye Cancer, Intraocular Melanoma, Retinoblastoma, fallopian tube cancer, fibrous histocytoma of bone, gallbladder cancer, stomach cancer, Gastrointestinal Carcinoid Tumor, Gastrointestinal Stromal Tumors, Germ Cell Tumors, Childhood Extracranial Germ Cell Tumors, Extragonadal Germ Cell Tumors, Ovarian Germ Cell Tumors, Testicular Cancer, Gestational Trophoblastic Disease, Hairy Cell Leukemia, Head and Neck Cancer, Hepatocellular (Liver) Cancer, Histiocytosis, Hodgkin Lymphoma, Hypopharyngeal Cancer, Head and Neck Cancer, Intraocular melanoma, islet cell tumors, Kaposi sarcoma, renal cell cancer, Langerhans Cell Histiocytosis, Laryngeal Cancer, Leukemia, Lip and Oral Cavity Cancer, Liver Cancer, Lymphoma, Male Breast Cancer, Malignant Fibrous Histiocytoma of Bone and Osteosarcoma, Melanoma Childhood Melanoma, Merkel Cell Carcinoma, Mesothelioma, Metastatic Cancer, Metastatic Squamous Neck Cancer with Occult Primary (Head and Neck Cancer), Midline Tract Carcinoma With NUT Gene Changes, Mouth Cancer (Head and Neck Cancer), Multiple Endocrine Neoplasia Syndromes, Multiple Myeloma/Plasma Cell Neoplasms, Mycosis Fungoides (Lymphoma), Myelodysplastic Syndromes, Myelodysplastic/Myeloproliferative Neoplasms, Myelogenous Leukemia, Chronic (CML), Myeloid Leukemia, Acute (AML), Myeloproliferative Neoplasms, Nasal Cavity and Paranasal Sinus Cancer (Head and Neck Cancer), Nasopharyngeal Cancer (Head and Neck Cancer), Neuroblastoma, Non-Hodgkin Lymphoma, Non-Small Cell Lung Cancer, Oral Cancer, Lip and Oral Cavity Cancer and Oropharyngeal Cancer, Osteosarcoma and Malignant Fibrous Histiocytoma of Bone, Ovarian Cancer, Pancreatic Cancer Pancreatic Neuroendocrine Tumors (Islet Cell Tumors), Papillomatosis, Paraganglioma Paranasal Sinus and Nasal Cavity Cancer, Parathyroid Cancer, Penile Cancer, Pharyngeal Cancer (Head and Neck Cancer), Pheochromocytoma, Pituitary Tumor, Plasma Cell Neoplasm/Multiple Myeloma, Pleuropulmonary Blastoma, Primary Central Nervous System (CNS) Lymphoma, Primary Peritoneal Cancer, Prostate Cancer, Rectal Cancer, Recurrent Cancers, Renal Cell Cancer, Retinoblatoma, Rhabdomyosarcoma, Salivary Gland Cancer, Childhood Rhabdomyosarcoma, Childhood Vascular Tumors, Ewing Sarcoma (Bone Cancer), Kaposi Sarcoma (Soft Tissue Sarcoma), Osteosarcoma (Bone Cancer), Uterine Sarcoma, Sézary Syndrome (Lymphoma), Skin Cancer, Small Cell Lung Cancer, Small Intestine Cancer, Soft Tissue Sarcoma, Squamous Cell Carcinoma of the Skin, Squamous Neck Cancer with Occult Primary, Metastatic (Head and Neck Cancer), Stomach (Gastric) Cancer, T-Cell Lymphoma, Testicular Cancer, Nasopharyngeal Cancer, Oropharyngeal Cancer, Hypopharyngeal Cancer, Thymoma and Thymic Carcinoma , Thyroid Cancer, Transitional Cell Cancer of the Renal Pelvis and Ureter, uretal and renal pelvis cancer, urethral cancer, uterine cancer, uterine sarcoma, vaginal cancer, vascular tumors, vulvar cancer, Wilms Tumor and other forms of cancer.

In some instances, an organelle of an animal cell can be isolated from other components of the animal cell and then the phenotype of the organelle and elemental content of the animal organelle can be quantified using the methods and systems described herein. The organelle phenotype (or a biological response of the organelle) can then be correlated to the measured elemental species. For example, the isolated organelle can include, but is not limited to, cell nucleus, nuclear membrane, microtubules, microfilaments, endoplasmic reticulum, sarcoplasmic reticulum, ribosome, mitochondria, vacuole, lysosome, cell membrane or other organelles present in an animal cell.

In some examples, the methods and systems described herein can also be used to analyze viruses, which may be present within a cell or outside of a cell or both. For example, the efficacy of a metal based anti-viral to bind to a virus protein coat may be assessed using the methods and systems described herein. Where viruses are analyzed, the virus may be, for example, a double stranded DNA virus, a single stranded DNA virus, a double stranded RNA virus, a positive sense single stranded RNA virus, a negative sense single stranded RNA virus, a single stranded RNA-reverse transcribing virus (retrovirus) or a double stranded DNA reverse transcribing virus. Various specific viruses include, but are not limited to, Papovaviridae, Adenoviridae, Herpesviridae, Herpesvirales, Ascoviridae, Ampullaviridae, Asfarviridae, Baculoviridae, Fuselloviridae, Globuloviridae, Guttaviridae, Hytrosaviridae, Iridoviridae, Lipothrixviridae, Nimaviridae, Poxviridae, Tectiviridae, Corticoviridae, Sulfolobus, Caudovirales, Corticoviridae, Tectiviridaea, Ligamenvirales, Ampullaviridae, Bicaudaviridae, Clavaviridae, Fuselloviridae, Globuloviridae, Guttaviridae, Turriviridae, Ascovirus, Baculovirus, Hytrosaviridae, Iridoviridae, Polydnaviruses, Mimiviridae, Marseillevirus, Megavirus, Mavirus virophage, Sputnik virophage, Nimaviridae, Phycodnaviridae, pleolipoviruses, Plasmaviridae, Pandoraviridae, Dinodnavirus, Rhizidiovirus, Salterprovirus, Sphaerolipoviridae, Anelloviridae, Bidnaviridae, Circoviridae, Geminiviridae, Genomoviridae, Inoviridae, Microviridae, Nanoviridae, Parvoviridae, Spiraviridae, Amalgaviridae, Birnaviridae, Chrysoviridae, Cystoviridae, Endornaviridae, Hypoviridae, Megabirnaviridae, Partitiviridae, Picobirnaviridae, Quadriviridae, Reoviridae, Totiviridae, Nidovirales, Picornavirales, Tymovirales, Mononegavirales, Bornaviridae, Filoviridae, Mymonaviridae, Nyamiviridae, Paramyxoviridae, Pneumoviridae, Rhabdoviridae, Sunviridae, Anphevirus, Arlivirus, Chengtivirus, Crustavirus, Wastrivirus, Bunyavirales, Feraviridae, Fimoviridae, Hantaviridae, Jonviridae, Nairoviridae, Peribunyaviridae, Phasmaviridae, Phenuiviridae, Tospoviridae, Arenaviridae, Ophioviridae, Orthomyxoviridae, Deltavirus, Taastrup virus, Alpharetrovirus, Avian leukosis virus; Rous sarcoma virus, Betaretrovirus, Mouse mammary tumor virus, Gammaretrovirus, Murine leukemia virus, Feline leukemia virus, Bovine leukemia virus, Human T-lymphotropic virus, Epsilonretrovirus, Walleye dermal sarcoma virus, Lentivirus, Human immunodeficiency virus 1, Simian and Feline immunodeficiency viruses, Spumavirus, Simian foamy virus, Orthoretrovirinae, Spumaretrovirinae, Metaviridae, Pseudoviridae, Retroviridae, Hepadnaviridae, or Caulimoviridae. Various species within these classes, orders, families and genera can be selected for analysis using the methods and systems described herein.

In certain configurations and as noted herein, the cell analyzer may detect one or more labels present on an antibody that binds specifically to a site on the individual cell. The antibody is generally a polypeptide which comprises a plurality of amino acids coupled to each other through peptide bonds. An antibody may comprise an immunoglobin chain or fragment thereof, comprising at least one immunoglobulin variable domain sequence. The term antibody includes, for example, a monoclonal antibody (including a full length antibody which has an immunoglobulin Fc region), a polyclonal antibody and other polypeptides that can specifically bind to one or more sites on a cell. In one embodiment, an antibody molecule comprises a full length antibody, or a full length immunoglobin chain. In another embodiment, an antibody molecule comprises an antigen binding or functional fragment of a full length antibody, or a full length immunoglobulin chain. The amino acids of the antibody may be natural or synthetic, and includes both an amino functionality and an acid functionality and is capable of being included in a polymer of naturally-occurring amino acids. Exemplary amino acids include naturally-occurring amino acids; analogs, derivatives and congeners thereof; amino acid analogs having variant side chains; and all stereoisomers of any of any of the foregoing. Both the D- or L-optical isomers of amino acids and peptidomimetics can be used. The term antibody also includes intact molecules as well as functional fragments thereof. Constant regions of the antibodies can be altered, e.g., mutated, to modify the properties of the antibody (e.g., to increase or decrease one or more of: Fc receptor binding, antibody glycosylation, the number of cysteine residues, effector cell function, or complement function).

If desired, the antibody can be produced using a conservative amino acid residue substitution where an amino acid residue is replaced with an amino acid residue having a similar side chain. Families of amino acid residues having similar side chains will be selected by the person of skill in the art, given the benefit of this disclosure. These families include amino acids with basic side chains (e.g., lysine, arginine, histidine), acidic side chains (e.g., aspartic acid, glutamic acid), uncharged polar side chains (e.g., glycine, asparagine, glutamine, serine, threonine, tyrosine, cysteine), nonpolar side chains (e.g., alanine, valine, leucine, isoleucine, proline, phenylalanine, methionine, tryptophan), beta-branched side chains (e.g., threonine, valine, isoleucine) and aromatic side chains (e.g., tyrosine, phenylalanine, tryptophan, histidine). The exact length of the antibody may vary as desired. In some instances, synthetic polypeptides can be coupled to each other to form an antibody. The antibody may be linear or branched, it may comprise modified amino acids, and it may be interrupted by non-amino acids. The antibody may be modified, for example, with disulfide bond formation, glycosylation, lipidation, acetylation, phosphorylation, or any other manipulation, such as conjugation with a label or labeling component. The polypeptide can be isolated from natural sources, can be a produced by recombinant techniques from a eukaryotic or prokaryotic host, or can be a product of synthetic procedures.

The antibody can be expressed in a host system by insertion of suitable nucleic acid sequences into the host organism. The terms “nucleic acid,” “nucleic acid sequence,” “nucleotide sequence,” or “polynucleotide sequence,” and “polynucleotide” are used interchangeably. These terms generally refer to a polymeric form of nucleotides of any length, either deoxyribonucleotides or ribonucleotides, or analogs thereof. The polynucleotide may be either single-stranded or double-stranded, and if single-stranded may be the coding strand or non-coding (antisense) strand. A polynucleotide may comprise modified nucleotides, such as methylated nucleotides and nucleotide analogs. The sequence of nucleotides may be interrupted by non-nucleotide components. A polynucleotide may be further modified after polymerization, such as by conjugation with a labeling component. The nucleic acid may be a recombinant polynucleotide, or a polynucleotide of genomic, cDNA, semisynthetic, or synthetic origin which either does not occur in nature or is linked to another polynucleotide in a non-natural arrangement.

The antibody can be isolated from a host or other expression or production organism. The term “isolated,” as used herein, refers to material that is removed from its original or native environment (e.g., the natural environment if it is naturally occurring). For example, a naturally-occurring polynucleotide or polypeptide present in a living animal is not isolated, but the same polynucleotide or polypeptide, separated by human intervention from some or all of the co-existing materials in the natural system, is isolated. Such polynucleotides could be part of a vector and/or such polynucleotides or polypeptides could be part of a composition, and still be isolated in that such vector or composition is not part of the environment in which it is found in nature.

In one configuration, the antibody molecule binds to an animal cell, e.g., a mammalian cell. For example, the antibody molecule binds specifically to an epitope, e.g., linear or conformational epitope, (e.g., an epitope as described herein) on the mammalian cell. In some embodiments, the antibody molecule binds to one or more extracellular Ig-like domains present on the mammalian cell, e.g., the first, second, third or fourth extracellular Ig-like domain of a specific epitope.

In an embodiment, an antibody molecule is a monospecific antibody molecule and binds to a single epitope, e.g., a monospecific antibody molecule having a plurality of immunoglobulin variable domain sequences, each of which binds the same epitope.

In another embodiment, an antibody molecule is a multi-specific antibody molecule, e.g., it comprises a plurality of immunoglobulin variable domains sequences, wherein a first immunoglobulin variable domain sequence of the plurality has binding specificity for a first epitope and a second immunoglobulin variable domain sequence of the plurality has binding specificity for a second epitope. In an embodiment, the first and second epitopes are on the same antigen, e.g., the same protein (or subunit of a multimeric protein). In other instances, the first and second epitopes overlap. In an embodiment, the first and second epitopes do not overlap. In another embodiment, the first and second epitopes are on different antigens, e.g., the different proteins (or different subunits of a multimeric protein). In an additional embodiment, a multi-specific antibody molecule comprises a third, fourth or fifth immunoglobulin variable domain. In an embodiment, a multi-specific antibody molecule is a bispecific antibody molecule, a tri-specific antibody molecule, or tetra-specific antibody molecule.

In some examples, a multi-specific antibody molecule can be a bispecific antibody molecule. A bispecific antibody has specificity for no more than two antigens or two binding sites. A bispecific antibody molecule is characterized by a first immunoglobulin variable domain sequence which has binding specificity for a first epitope and a second immunoglobulin variable domain sequence that has binding specificity for a second epitope. In another embodiment, the first and second epitopes are on the same antigen, e.g., the same protein (or subunit of a multimeric protein). In one embodiment, the first and second epitopes overlap. In another embodiment, the first and second epitopes do not overlap. In an embodiment, the first and second epitopes are on different antigens, e.g., the different proteins (or different subunits of a multimeric protein). In other embodiments, a bispecific antibody molecule comprises a heavy chain variable domain sequence and a light chain variable domain sequence which have binding specificity for a first epitope and a heavy chain variable domain sequence and a light chain variable domain sequence which have binding specificity for a second epitope. In other instances, a bispecific antibody molecule comprises a half antibody having binding specificity for a first epitope and a half antibody having binding specificity for a second epitope. In an additional embodiment, a bispecific antibody molecule comprises a half antibody, or fragment thereof, having binding specificity for a first epitope and a half antibody, or fragment thereof, having binding specificity for a second epitope. In an embodiment a bispecific antibody molecule comprises a single-chain variable fragment (scFv), or fragment thereof, have binding specificity for a first epitope and a scFv, or fragment thereof, have binding specificity for a second epitope.

In other configurations, an antibody molecule comprises a diabody, and a single-chain molecule, as well as an antigen-binding fragment of an antibody (e.g., Fab, F(ab′) ₂, and Fv). For example, an antibody molecule can include a heavy (H) chain variable domain sequence (abbreviated herein as VH), and a light (L) chain variable domain sequence (abbreviated herein as VL). In one embodiment, an antibody molecule comprises or consists of a heavy chain and a light chain (referred to herein as a half antibody). In another example, an antibody molecule includes two heavy (H) chain variable domain sequences and two light (L) chain variable domain sequence, thereby forming two antigen binding sites, such as Fab, Fab′, F(ab′)₂, Fc, Fd, Fd′, Fv, single chain antibodies (scFv for example), single variable domain antibodies, diabodies (Dab) (bivalent and bispecific), and chimeric (e.g., humanized) antibodies, which may be produced by the modification of whole antibodies or those synthesized de novo using recombinant DNA technologies. Without wishing to be bound by any one configuration, these functional antibody fragments generally retain the ability to selectively bind with their respective antigen or receptor. Antibodies and antibody fragments can be from any class of antibodies including, but not limited to, IgG, IgA, IgM, IgD, and IgE, and from any subclass (e.g., IgG1, IgG2, IgG3, and IgG4) of antibodies. The preparation of antibody molecules can be monoclonal or polyclonal. An antibody molecule can also be a human, humanized, CDR-grafted, or in vitro generated antibody. The antibody can have a heavy chain constant region chosen from, e.g., IgG1, IgG2, IgG3, or IgG4. The antibody can also have a light chain chosen from, e.g., kappa or lambda. The term “immunoglobulin” (Ig) is used interchangeably with the term “antibody” herein.

Examples of antigen-binding fragments of an antibody molecule include: (i) a Fab fragment, a monovalent fragment consisting of the VL, VH, CL and CH1 domains; (ii) a F(ab′)2 fragment, a bivalent fragment comprising two Fab fragments linked by a disulfide bridge at the hinge region; (iii) a Fd fragment consisting of the VH and CH1 domains; (iv) a Fv fragment consisting of the VL and VH domains of a single arm of an antibody, (v) a diabody (dAb) fragment, which consists of a VH domain; (vi) a camelid or camelized variable domain; (vii) a single chain Fv (scFv), see e.g., Bird et al. (1988) Science 242:423-426; and Huston et al. (1988) Proc. Natl. Acad. Sci. USA 85:5879-5883); (viii) a single domain antibody. These antibody fragments are obtained using conventional techniques known to those with skill in the art, and the fragments are screened for utility in the same manner as are intact antibodies.

In some examples, antibodies which can be used in the methods and systems described herein can also be single domain antibodies. Single domain antibodies can include antibodies whose complementary determining regions are part of a single domain polypeptide. Examples include, but are not limited to, heavy chain antibodies, antibodies naturally devoid of light chains, single domain antibodies derived from conventional 4-chain antibodies, engineered antibodies and single domain scaffolds other than those derived from antibodies. Single domain antibodies may be any present in the art or any future single domain antibodies. Single domain antibodies may be derived from any species including, but not limited to mouse, human, primates, camel, llama, fish, shark, goat, rabbit, and bovine. A single domain antibody is a naturally occurring single domain antibody known as heavy chain antibody devoid of light chains. Such single domain antibodies are described, for example, in WO 94/04678. For clarity reasons, this variable domain derived from a heavy chain antibody naturally devoid of light chain is known herein as a VHH or nanobody to distinguish it from the conventional VH of four chain immunoglobulins. Such a VHH molecule can be derived from antibodies raised in Camelidae species, for example in camel, llama, dromedary, alpaca and guanaco. Other species besides Camelidae may produce heavy chain antibodies naturally devoid of light chain; such VHHs are within the scope of the invention.

In certain examples, the VH and VL regions can be subdivided into regions of hypervariability, termed “complementarity determining regions” (CDR), interspersed with regions that are more conserved, termed “framework regions” (FR or FW). The extent of the framework region and CDRs has been precisely defined by a number of methods (see, Kabat, E. A., et al. (1991) Sequences of Proteins of Immunological Interest, Fifth Edition, U.S. Department of Health and Human Services, NIH Publication No. 91-3242; Chothia, C. et al. (1987) J. Mol. Biol. 196:901-917; and the AbM definition used by Oxford Molecular's AbM antibody modeling software. See, generally, e.g., Protein Sequence and Structure Analysis of Antibody Variable Domains. In: Antibody Engineering Lab Manual (Ed.: Duebel, S. and Kontermann, R., Springer-Verlag, Heidelberg). The terms “complementarity determining region,” and “CDR,” as used herein refer to the sequences of amino acids within antibody variable regions which confer antigen specificity and binding affinity. In general, there are three CDRs in each heavy chain variable region (HCDR1, HCDR2, HCDR3) and three CDRs in each light chain variable region (LCDR1, LCDR2, LCDR3). The precise amino acid sequence boundaries of a given CDR can be determined using any of a number of well-known schemes, including those described by Kabat et al. (1991), “Sequences of Proteins of Immunological Interest,” 5th Ed. Public Health Service, National Institutes of Health, Bethesda, Md. (“Kabat” numbering scheme), AL-Lazikani et al., (1997) JMB 273, 927-948 (“Chothia” numbering scheme). As used herein, the CDRs defined according the “Chothia” number scheme are also sometimes referred to as “hypervariable loops.”

For example, under Kabat, the CDR amino acid residues in the heavy chain variable domain (VH) are numbered 31-35 (HCDR1), 50-65 (HCDR2), and 95-102 (HCDR3); and the CDR amino acid residues in the light chain variable domain (VL) are numbered 24-34 (LCDR1), 50-56 (LCDR2), and 89-97 (LCDR3). Under Chothia the CDR amino acids in the VH are numbered 26-32 (HCDR1), 52-56 (HCDR2), and 95-102 (HCDR3); and the amino acid residues in VL are numbered 26-32 (LCDR1), 50-52 (LCDR2), and 91-96 (LCDR3). By combining the CDR definitions of both Kabat and Chothia, the CDRs consist of amino acid residues 26-35 (HCDR1), 50-65 (HCDR2), and 95-102 (HCDR3) in human VH and amino acid residues 24-34 (LCDR1), 50-56 (LCDR2), and 89-97 (LCDR3) in human VL. Unless specifically indicated, the antibody molecules can include any combination of one or more Kabat CDRs and/or Chothia hypervariable loops. Under all definitions, each VH and VL typically includes three CDRs and four FRs, arranged from amino-terminus to carboxy-terminus in the following order: FR1, CDR1, FR2, CDR2, FR3, CDR3, FR4. An immunoglobulin variable domain sequence refers to an amino acid sequence which can form the structure of an immunoglobulin variable domain. For example, the sequence may include all or part of the amino acid sequence of a naturally-occurring variable domain. For example, the sequence may or may not include one, two, or more N- or C-terminal amino acids, or may include other alterations that are compatible with formation of the protein structure.

In certain examples, the antibody generally comprises one or more antigen-binding sites or epitopes. The term antigen-binding site refers to the part of an antibody molecule that comprises determinants that form an interface that binds to the cell site, or an epitope thereof. With respect to proteins (or protein mimetics), the antigen-binding site typically includes one or more loops (of at least four amino acids or amino acid mimics) that form an interface that binds to a polypeptide of the cell. Typically, the antigen-binding site of an antibody molecule includes at least one or two CDRs and/or hypervariable loops, or more typically at least three, four, five or six CDRs and/or hypervariable loops.

In some examples, different antibodies may compete with each other to bind to a specific epitope or site of the cell. The terms “compete” or “cross-compete” are used interchangeably herein to refer to the ability of an antibody molecule to interfere with binding of another antibody molecule. The interference with binding can be direct or indirect (e.g., through an allosteric modulation of the antibody molecule or the target). The extent to which an antibody molecule is able to interfere with the binding of another antibody molecule to the target, and therefore whether it can be said to compete, can be determined using a competition binding assay, for example, a FACS assay, an ELISA or BIACORE assay. In some embodiments, a competition binding assay is a quantitative competition assay. In some embodiments, a first antibody molecule is said to compete for binding to the target with a second antibody molecule when the binding of the first antibody molecule to the target is reduced by 10% or more, e.g., 20% or more, 30% or more, 40% or more, 50% or more, 55% or more, 60% or more, 65% or more, 70% or more, 75% or more, 80% or more, 85% or more, 90% or more, 95% or more, 98% or more, 99% or more in a competition binding assay (e.g., a competition assay described herein). As used herein, the term “epitope” refers to the moieties of an antigen that specifically interact with an antibody molecule. Such moieties, referred to herein as epitopic determinants, typically comprise, or are part of, elements such as amino acid side chains or sugar side chains. An epitopic determinate can be defined by methods known in the art or disclosed herein, e.g., by crystallography or by hydrogen-deuterium exchange. At least one or some of the moieties on the antibody molecule, that specifically interact with an epitopic determinant, are typically located in a CDR(s). Typically an epitope has specific three dimensional structural characteristics. An epitope may also comprise specific charge characteristics. Some epitopes are linear epitopes while others are conformational epitopes.

In some examples, the antibodies that can be used in the methods described herein may be monoclonal antibodies. The terms “monoclonal antibody” or “monoclonal antibody composition” as used herein refers to a preparation of antibody molecules of single molecular composition. A monoclonal antibody composition displays a single binding specificity and affinity for a particular epitope. A monoclonal antibody can be made by hybridoma technology or by methods that do not use hybridoma technology (e.g., recombinant methods).

In other examples, the antibody molecule can be a polyclonal or a monoclonal antibody. In other embodiments, the antibody can be recombinantly produced, e.g., produced by phage display or by combinatorial methods. For example, phage display and combinatorial methods for generating antibodies are known in the art (as described in, e.g., Ladner et al. U.S. Pat. No. 5,223,409; Kang et al. International Publication No. WO 92/18619; Dower et al. International Publication No. WO 91/17271; Winter et al. International Publication WO 92/20791; Markland et al. International Publication No. WO 92/15679; Breitling et al. International Publication WO 93/01288; McCafferty et al. International Publication No. WO 92/01047; Garrard et al. International Publication No. WO 92/09690; Ladner et al. International Publication No. WO 90/02809; Fuchs et al. (1991) Bio/Technology 9:1370-1372; Hay et al. (1992) Hum Antibod Hybridomas 3:81-85; Huse et al. (1989) Science 246:1275-1281; Griffiths et al. (1993) EMBO J 12:725-734; Hawkins et al. (1992) J Mol Biol 226:889-896; Clackson et al. (1991) Nature 352:624-628; Gram et al. (1992) PNAS 89:3576-3580; Garrad et al. (1991) Bio/Technology 9:1373-1377; Hoogenboom et al. (1991) Nuc Acid Res 19:4133-4137; and Barbas et al. (1991) PNAS 88:7978-7982, the contents of all of which are incorporated by reference herein).

In one embodiment, the antibody is a fully human antibody (e.g., an antibody made in a mouse which has been genetically engineered to produce an antibody from a human immunoglobulin sequence), or a non-human antibody, e.g., a rodent (mouse or rat), goat, primate (e.g., monkey), camel antibody. Preferably, the non-human antibody is a rodent (mouse or rat antibody). Methods of producing rodent antibodies are known in the art. Human monoclonal antibodies can be generated using transgenic mice carrying the human immunoglobulin genes rather than the mouse system. Splenocytes from these transgenic mice immunized with the antigen of interest are used to produce hybridomas that secrete human monoclonal antibodies (mAbs) with specific affinities for epitopes from a human protein (see, e.g., Wood et al. International Application WO 91/00906, Kucherlapati et al. PCT publication WO 91/10741; Lonberg et al. International Application WO 92/03918; Kay et al. International Application 92/03917; Lonberg, N. et al. 1994 Nature 368:856-859; Green, L. L. et al. 1994 Nature Genet. 7:13-21; Morrison, S. L. et al. 1994 Proc. Natl. Acad. Sci. USA 81:6851-6855; Bruggeman et al. 1993 Year Immunol 7:33-40; Tuaillon et al. 1993 PNAS 90:3720-3724; Bruggeman et al. 1991 Eur J Immunol 21:1323-1326). An antibody can be one in which the variable region, or a portion thereof, e.g., the CDRs, are generated in a non-human organism, e.g., a rat or mouse. Chimeric, CDR-grafted, and humanized antibodies can be used. Antibodies generated in a non-human organism, e.g., a rat or mouse, and then modified, e.g., in the variable framework or constant region, to decrease antigenicity in a human. Chimeric antibodies can be produced by recombinant DNA techniques known in the art (see Robinson et al., International Patent Publication PCT/US86/02269; Akira, et al., European Patent Application 184,187; Taniguchi, M., European Patent Application 171,496; Morrison et al., European Patent Application 173,494; Neuberger et al., International Application WO 86/01533; Cabilly et al. U.S. Pat. No. 4,816,567; Cabilly et al., European Patent Application 125,023; Better et al. (1988 Science 240:1041-1043); Liu et al. (1987) PNAS 84:3439-3443; Liu et al., 1987, J. Immunol. 139:3521-3526; Sun et al. (1987) PNAS 84:214-218; Nishimura et al., 1987, Canc. Res. 47:999-1005; Wood et al. (1985) Nature 314:446-449; and Shaw et al., 1988, J. Natl Cancer Inst. 80:1553-1559).

In certain examples, a humanized or CDR-grafted antibody will have at least one or two but generally all three recipient CDRs (of heavy and or light immunoglobulin chains) replaced with a donor CDR. The antibody may be replaced with at least a portion of a non-human CDR or only some of the CDRs may be replaced with non-human CDRs. It may only be desirable to replace the number of CDRs required for binding of the humanized antibody to a particular epitope. Preferably, the donor will be a rodent antibody, e.g., a rat or mouse antibody, and the recipient will be a human framework or a human consensus framework. Typically, the immunoglobulin providing the CDRs is called the “donor” and the immunoglobulin providing the framework is called the “acceptor.” In one embodiment, the donor immunoglobulin is a non-human (e.g., rodent). The acceptor framework is a naturally-occurring (e.g., a human) framework or a consensus framework, or a sequence about 85% or higher, preferably 90%, 95%, 99% or higher identical thereto. As used herein, the term “consensus sequence” refers to the sequence formed from the most frequently occurring amino acids (or nucleotides) in a family of related sequences (See e.g., Winnaker, From Genes to Clones (Verlagsgesellschaft, Weinheim, Germany 1987). In a family of proteins, each position in the consensus sequence is occupied by the amino acid occurring most frequently at that position in the family. If two amino acids occur equally frequently, either can be included in the consensus sequence. A “consensus framework” refers to the framework region in the consensus immunoglobulin sequence.

In some examples, an antibody can be humanized by methods known in the art (see e.g., Morrison, S. L., 1985, Science 229:1202-1207, by Oi et al., 1986, BioTechniques 4:214, and by Queen et al. U.S. Pat. Nos. 5,585,089, 5,693,761 and 5,693,762, the contents of all of which are hereby incorporated by reference). Humanized or CDR-grafted antibodies can be produced by CDR-grafting or CDR substitution, wherein one, two, or all CDRs of an immunoglobulin chain can be replaced. See e.g., U.S. Pat. No. 5,225,539; Jones et al. 1986 Nature 321:552-525; Verhoeyan et al. 1988 Science 239:1534; Beidler et al. 1988 J. Immunol. 141:4053-4060; Winter U.S. Pat. No. 5,225,539, the contents of all of which are hereby expressly incorporated by reference. Winter describes a CDR-grafting method which may be used to prepare humanized antibodies (UK Patent Application GB 2188638A, filed on Mar. 26, 1987; Winter U.S. Pat. No. 5,225,539), the contents of which is expressly incorporated by reference. Humanized antibodies in which specific amino acids have been substituted, deleted or added can also be used. Criteria for selecting amino acids from the donor are described, for example, in U.S. Pat. No. 5,585,089, e.g., columns 12-16 of U.S. Pat. No. 5,585,089, the e.g., columns 12-16 of U.S. Pat. No. 5,585,089, the contents of which are hereby incorporated by reference. Other techniques for humanizing antibodies are described in Padlan et al. EP 519596 A1, published on Dec. 23, 1992.

In some examples, the antibody molecule can be a single chain antibody. A single-chain antibody (scFV) may be engineered (see, for example, Colcher, D. et al. (1999) Ann N Y Acad Sci 880:263-80; and Reiter, Y. (1996) Clin Cancer Res 2:245-52). The single chain antibody can be dimerized or multimerized to generate multivalent antibodies having specificities for different epitopes of the same target protein. In yet other embodiments, the antibody molecule has a heavy chain constant region chosen from, e.g., the heavy chain constant regions of IgG1, IgG2, IgG3, IgG4, IgM, IgA1, IgA2, IgD, and IgE; particularly, chosen from, e.g., the (e.g., human) heavy chain constant regions of IgG1, IgG2, IgG3, and IgG4. In another embodiment, the antibody molecule has a light chain constant region chosen from, e.g., the (e.g., human) light chain constant regions of kappa or lambda. The constant region can be altered, e.g., mutated, to modify the properties of the antibody (e.g., to increase or decrease one or more of: Fc receptor binding, antibody glycosylation, the number of cysteine residues, effector cell function, and/or complement function). In one embodiment the antibody has: effector function; and can fix complement. In other embodiments the antibody does not; recruit effector cells; or fix complement. In another embodiment, the antibody has reduced or no ability to bind an Fc receptor. For example, it is an isotype or subtype, fragment or other mutant, which does not support binding to an Fc receptor, e.g., it has a mutagenized or deleted Fc receptor binding region.

Methods for altering an antibody constant region are known in the art. Antibodies with altered function, e.g., altered affinity for an effector ligand, such as FcR on a cell, or the C1 component of complement can be produced by replacing at least one amino acid residue in the constant portion of the antibody with a different residue (see e.g., EP 388,151 A1, U.S. Pat. Nos. 5,624,821 and 5,648,260, the contents of all of which are hereby incorporated by reference). Similar type of alterations could be described which if applied to the murine, or other species immunoglobulin would reduce or eliminate these functions.

In certain examples, an antibody can be derivatized or linked to another functional molecule (e.g., another peptide or protein) or conjugated to a label. As used herein, a “derivatized” antibody is one that has been modified. Methods of derivatization include but are not limited to the addition of a fluorescent moiety, light scattering moiety, light emitting moiety, complexed with a metal, a radionucleotide, a toxin, an enzyme or an affinity ligand such as biotin. The antibody can include derivatized and otherwise modified forms of the antibodies, including immunoadhesion molecules. For example, an antibody molecule can be functionally linked (by chemical coupling, genetic fusion, noncovalent association or otherwise) to one or more other molecular entities, such as another antibody (e.g., a bispecific antibody or a diabody), a detectable agent, one or more labels, a cytotoxic agent, a pharmaceutical agent, and/or a protein or peptide that can mediate association of the antibody or antibody portion with another molecule (such as a streptavidin core region or a polyhistidine tag). One type of derivatized antibody molecule is produced by crosslinking two or more antibodies (of the same type or of different types, e.g., to create bispecific antibodies). Suitable crosslinkers include those that are heterobifunctional, having two distinctly reactive groups separated by an appropriate spacer (e.g., m-maleimidobenzoyl-N-hydroxysuccinimide ester) or homobifunctional (e.g., disuccinimidyl suberate). Such linkers are available from Pierce Chemical Company, Rockford, Ill.

In some examples, the antibody may comprise a detectable label which is selected based on the particular technique to be implemented in the cell analyzer. Useful detectable agents with which an antibody molecule may be derivatized (or labeled) include fluorescent compounds, various enzymes, prosthetic groups, luminescent materials, bioluminescent materials, fluorescent emitting metal atoms, e.g., europium (Eu), phosphorescent labels and phosphorescent emitting metal atoms, and transition metals, lanthanides, and radioactive materials (described below). Exemplary fluorescent labels include, but are not limited to, fluorescein, fluorescein isothiocyanate, rhodamine, 5-dimethylamine-1-napthalenesulfonyl chloride, phycoerythrin and the like. An antibody may also be derivatized with detectable enzymes, such as alkaline phosphatase, horseradish peroxidase, beta-galactosidase, acetylcholinesterase, glucose oxidase and the like. When an antibody is derivatized with a detectable enzyme, it is detected by adding additional reagents that the enzyme uses to produce a detectable reaction product. For example, when the detectable agent horseradish peroxidase is present, the addition of hydrogen peroxide and diaminobenzidine leads to a colored reaction product, which is detectable. An antibody molecule may also be derivatized with a prosthetic group (e.g., streptavidin/biotin and avidin/biotin). For example, an antibody may be derivatized with biotin, and detected through indirect measurement of avidin or streptavidin binding. Other examples of suitable fluorescent materials include umbelliferone, fluorescein, fluorescein isothiocyanate, rhodamine, dichlorotriazinylamine fluorescein, dansyl chloride or phycoerythrin; an example of a luminescent material includes luminol, and examples of bioluminescent materials include luciferase, luciferin, and aequorin.

Labeled antibody molecule can be used, for example, to characterize one or more phenotypes or biological responses of the cell using the cell analyzer. The antibody is typically used to detect the presence (or absence) of an antigen in order to evaluate the abundance and pattern of expression of the protein, to monitor protein levels in tissue as part of a clinical testing procedure, e.g., to determine the efficacy of a given treatment regimen or to otherwise differentiate certain cells in a cell population from each other.

In certain embodiments, an antibody molecule may be conjugated to another molecular entity, typically a label or a therapeutic (e.g., a cytotoxic or cytostatic) agent or moiety. Radioactive isotopes can be used in diagnostic or therapeutic applications and may also be measured using the mass spectrometry methods and systems described herein. Radioactive isotopes that can be coupled to the antibodies include, but are not limited to alpha-, beta-, or gamma-emitters, or beta- and gamma-emitters. Such radioactive isotopes include, but are not limited to iodine (¹³¹I or ¹²⁵I), yttrium (⁹⁰Y), lutetium (¹⁷⁷Lu), actinium (²²⁵Ac), praseodymium, astatine (²¹¹At), rhenium (¹⁸⁶Re), bismuth (²¹²Bi or ²¹³Bi), indium (¹¹¹In), technetium (^{99m}Tc), phosphorus (³²P), rhodium (¹⁸⁸Rh), sulfur (³⁵S), carbon (¹⁴C), tritium (³H), chromium (⁵¹Cr), chlorine (³⁶Cl), cobalt (⁵⁷Co or ⁵⁸Co), iron (⁵⁹Fe), selenium (⁷⁵Se), or gallium (⁶⁷Ga). Radioisotopes useful as therapeutic agents include, but are not limited to, yttrium (⁹⁰Y), lutetium (¹⁷⁷Lu), actinium (²²⁵Ac), praseodymium, astatine (²¹¹At), rhenium (¹⁸⁶Re), bismuth (²¹²Bi or ²¹³Bi), and rhodium (¹⁸⁸Rh). Radioisotopes useful as labels, e.g., for use in diagnostics, include iodine (¹³¹I or ¹²⁵I), indium (¹¹¹In), technetium (^{99m}Tc), phosphorus (³²P), carbon (¹⁴C), and tritium (³H), or one or more of the therapeutic isotopes listed above. The mass spectrometer can be used to detect whether or not these radioisotopes have been taken up by a particular cell and how much of the radioisotope is present in each individual cell.

As is discussed above, the antibody molecule can also be conjugated to a therapeutic agent. Therapeutically active radioisotopes have already been mentioned. Examples of other therapeutic agents include taxol, cytochalasin B, gramicidin D, ethidium bromide, emetine, mitomycin, etoposide, tenoposide, vincristine, vinblastine, colchicine, doxorubicin, daunorubicin, dihydroxy anthracin dione, mitoxantrone, mithramycin, actinomycin D, 1-dehydrotestosterone, glucocorticoids, procaine, tetracaine, lidocaine, propranolol, puromycin, maytansinoids, e.g., maytansinol (see U.S. Pat. No. 5,208,020), CC-1065 (see U.S. Pat. Nos. 5,475,092, 5,585,499, 5,846,545) and analogs or homologs thereof. Therapeutic agents include, but are not limited to, antimetabolites (e.g., methotrexate, 6-mercaptopurine, 6-thioguanine, cytarabine, 5-fluorouracil decarbazine), alkylating agents (e.g., mechlorethamine, thioepa chlorambucil, CC-1065, melphalan, carmustine (BSNU) and lomustine (CCNU), cyclothosphamide, busulfan, dibromomannitol, streptozotocin, mitomycin C, and cis-dichlorodiamine platinum (II) (DDP) cisplatin), anthracyclinies (e.g., daunorubicin (formerly daunomycin) and doxorubicin), antibiotics (e.g., dactinomycin (formerly actinomycin), bleomycin, mithramycin, and anthramycin (AMC)), and anti-mitotic agents (e.g., vincristine, vinblastine, taxol and maytansinoids). If desired, the antibody can be conjugated to both a therapeutic agent and a detectable label. Efficacy of treatment using the therapeutic conjugated antibody may be assessed using the systems and methods described herein.

In certain embodiments, the antibody molecule is a multi-specific (e.g., a bispecific or a tri-specific) antibody molecule. Protocols for generating bispecific or heterodimeric antibody molecules are known in the art; including but not limited to, for example, the “knob in a hole” approach described in, e.g., U.S. Pat. No. 5,731,168; the electrostatic steering Fc pairing as described in, e.g., WO 09/089004, WO 06/106905 and WO 2010/129304; Strand Exchange Engineered Domains (SEED) heterodimer formation as described in, e.g., WO 07/110205; Fab arm exchange as described in, e.g., WO 08/119353, WO 2011/131746, and WO 2013/060867; double antibody conjugate, e.g., by antibody cross-linking to generate a bi-specific structure using a heterobifunctional reagent having an amine-reactive group and a sulfhydryl reactive group as described in, e.g., U.S. Pat. No. 4,433,059; bispecific antibody determinants generated by recombining half antibodies (heavy-light chain pairs or Fabs) from different antibodies through cycle of reduction and oxidation of disulfide bonds between the two heavy chains, as described in, e.g., U.S. Pat. No. 4,444,878; trifunctional antibodies, e.g., three Fab′ fragments cross-linked through sulfhydryl reactive groups, as described in, e.g., U.S. Pat. No. 5,273,743; biosynthetic binding proteins, e.g., pair of scFvs cross-linked through C-terminal tails preferably through disulfide or amine-reactive chemical cross-linking, as described in, e.g., U.S. Pat. No. 5,534,254; bifunctional antibodies, e.g., Fab fragments with different binding specificities dimerized through leucine zippers (e.g., c-fos and c-jun) that have replaced the constant domain, as described in, e.g., U.S. Pat. No. 5,582,996; bispecific and oligospecific mono- and oligovalent receptors, e.g., VH-CH1 regions of two antibodies (two Fab fragments) linked through a polypeptide spacer between the CH1 region of one antibody and the VH region of the other antibody typically with associated light chains, as described in, e.g., U.S. Pat. No. 5,591,828; bispecific DNA-antibody conjugates, e.g., crosslinking of antibodies or Fab fragments through a double stranded piece of DNA, as described in, e.g., U.S. Pat. No. 5,635,602; bispecific fusion proteins, e.g., an expression construct containing two scFvs with a hydrophilic helical peptide linker between them and a full constant region, as described in, e.g., U.S. Pat. No. 5,637,481; multivalent and multi-specific binding proteins, e.g., dimer of polypeptides having first domain with binding region of Ig heavy chain variable region, and second domain with binding region of Ig light chain variable region, generally termed diabodies (higher order structures are also encompassed creating for bispecific, trispecific, or tetra-specific molecules, as described in, e.g., U.S. Pat. No. 5,837,242; minibody constructs with linked VL and VH chains further connected with peptide spacers to an antibody hinge region and CH3 region, which can be dimerized to form bispecific/multivalent molecules, as described in, e.g., U.S. Pat. No. 5,837,821; VH and VL domains linked with a short peptide linker (e.g., 5 or 10 amino acids) or no linker at all in either orientation, which can form dimers to form bispecific diabodies; trimers and tetramers, as described in, e.g., U.S. Pat. No. 5,844,094; String of VH domains (or VL domains in family members) connected by peptide linkages with crosslinkable groups at the C-terminus further associated with VL domains to form a series of FVs (or scFvs), as described in, e.g., U.S. Pat. No. 5,864,019; and single chain binding polypeptides with both a VH and a VL domain linked through a peptide linker are combined into multivalent structures through non-covalent or chemical crosslinking to form, e.g., homobivalent, heterobivalent, trivalent, and tetravalent structures using both scFV or diabody type format, as described in, e.g., U.S. Pat. No. 5,869,620. Additional exemplary multi-specific and bispecific molecules and methods of making the same are found, for example, in U.S. Pat. Nos. 5,910,573, 5,932,448, 5,959,083, 5,989,830, 6,005,079, 6,239,259, 6,294,353, 6,333,396, 6,476,198, 6,511,663, 6,670,453, 6,743,896, 6,809,185, 6,833,441, 7,129,330, 7,183,076, 7,521,056, 7,527,787, 7,534,866, 7,612,181, US2002004587A1, US2002076406A1, US2002103345A1, US2003207346A1, US2003211078A1, US2004219643A1, US2004220388A1, US2004242847A1, US2005003403A1, US2005004352A1, US2005069552A1, US2005079170A1, US2005100543A1, US2005136049A1, US2005136051A1, US2005163782A1, US2005266425A1, US2006083747A1, US2006120960A1, US2006204493A1, US2006263367A1, US2007004909A1, US2007087381A1, US2007128150A1, US2007141049A1, US2007154901A1, US2007274985A1, US2008050370A1, US2008069820A1, US2008152645A1, US2008171855A1, US2008241884A1, US2008254512A1, US2008260738A1, US2009130106A1, US2009148905A1, US2009155275A1, US2009162359A1, US2009162360A1, US2009175851A1, US2009175867A1, US2009232811A1, US2009234105A1, US2009263392A1, US2009274649A1, EP346087A2, WO0006605A2, WO02072635A2, WO04081051A1, WO06020258A2, WO2007044887A2, WO2007095338A2, WO2007137760A2, WO2008119353A1, WO2009021754A2, WO2009068630A1, WO9103493A1, WO9323537A1, WO9409131A1, WO9412625A2, WO9509917A1, WO9637621A2, WO9964460A1.

In other embodiments, the antibody molecule (e.g., a monospecific, bispecific, or multi-specific antibody molecule) is covalently linked, e.g., fused, to another partner e.g., a protein e.g., one, two or more cytokines, e.g., as a fusion molecule for example a fusion protein. In other embodiments, the fusion molecule comprises one or more proteins, e.g., one, two or more cytokines. In one embodiment, the cytokine is an interleukin (IL) chosen from one, two, three or more of IL-1, IL-2, IL-12, IL-15 or IL-21. In one embodiment, a bispecific antibody molecule has a first binding specificity to a first target, a second binding specificity to a second target, and is optionally linked to an interleukin (e.g., IL-12) domain e.g., full length IL-12 or a portion thereof. A “fusion protein” and a “fusion polypeptide” refer to a polypeptide having at least two portions covalently linked together, where each of the portions is a polypeptide having a different property. The property may be a biological property, such as activity in vitro or in vivo. The property can also be simple chemical or physical property, such as binding to a target molecule, catalysis of a reaction, etc. The two portions can be linked directly by a single peptide bond or through a peptide linker, but are in reading frame with each other. If desired the fusion protein may comprise a detectable label which can be detected using the cell analyzers described herein.

In instances where a magnetic label is used along with magnetic cell sorting, the magnetic label may comprise magnetic, paramagnetic or superparamagnetic nanoparticles which are typically about 50-100 nm on average in size. The magnetic label can be placed inside a column so as the cells pass through the column the cells which specifically bind to the magnetic labels are captured. Cells which do not bind to a magnetic label can pass through. The bound cells can be eluted later by switching off the magnetic field and permitting the cells to elute from the column. In some examples, Dynabeads or other spherical beads of a larger size, e.g., 1-5 microns on average, could instead be used. Suitable magnetic labels and beads are commercially available, for example, from Miltenyi Biotec Inc. (Auburn, Calif.).

Certain specific examples are described to better illustrate some of the novel features described herein.

### EXAMPLE 1

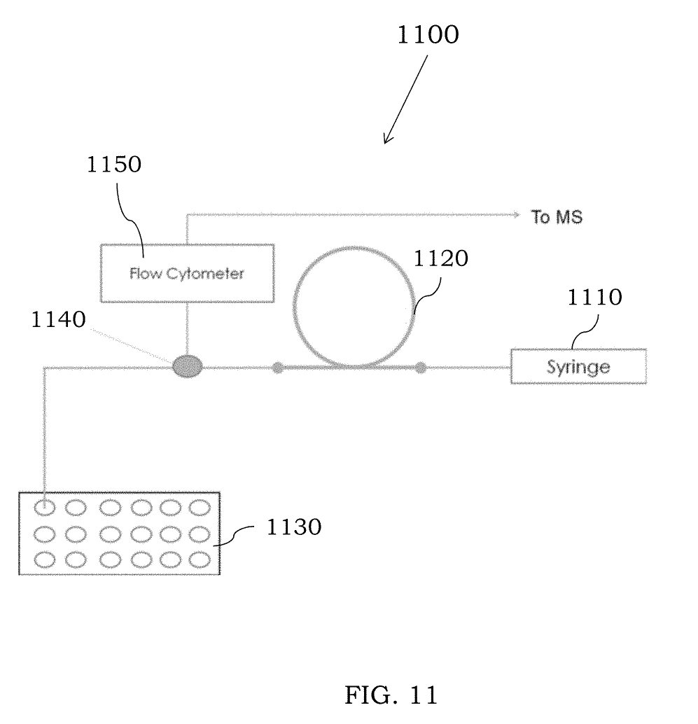

One illustration of a system that can be used to measure one or more properties of an individual cell and measure an amount of at least one element in the individual cell is shown in FIG. 11. The system 1100 comprises a syringe 1110, a loop 1120, a microtiter plate 1130, a valve/switch 1140, and a flow cytometer 1150 fluidically coupled to a mass spectrometer (not shown). The loop 1120 may be configured to hold a volume of about 100-300 microliters. The loop 1120 can be used to provide a linear flow into the flow cytometer 1150. In use of the system 1100, the loop 1120 can be filled by the syringe 1110. The valve/switch 1140 can be actuated so that the cells are provided to the flow cytometer 1150 from the microtiter plate 1130. As each individual cell passes through the flow cytometer 1150, a pulse in the flow cytometer 1150 can be correlated to a pulse in a mass spectrometer (not shown). The different measurements can be correlated to provide information on metal content and biological response of the cells.

### EXAMPLE 2

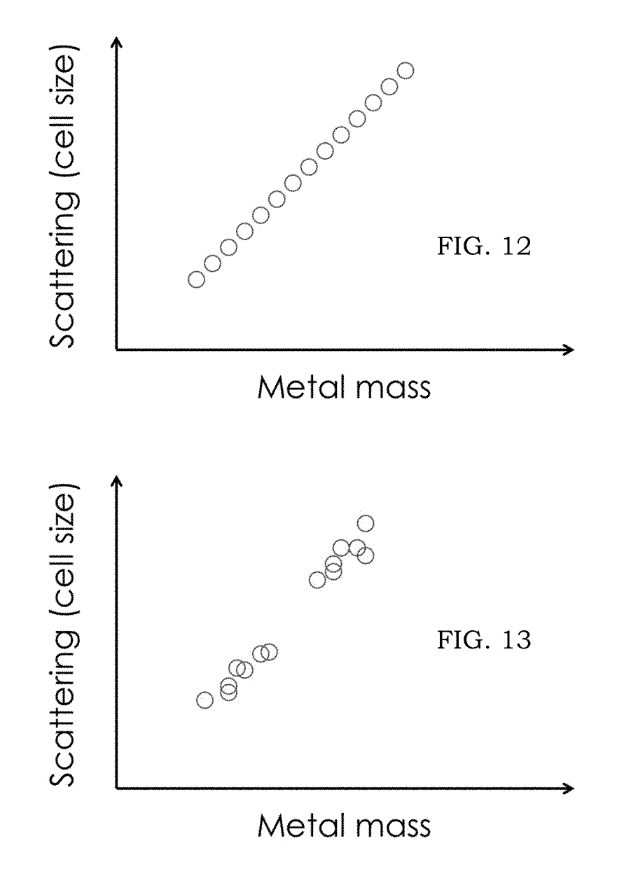

Referring to FIG. 12, a graph is shown illustrating possible data which may be obtained and used to correlate cell size with measured metal mass in each cell. As can be seen in FIG. 12, as cell size increases a substantially linear increase in metal mass within the cell increases. This data could be representative of linear uptake of a metal agent into a cell based on the size of the cell.

### EXAMPLE 3

Referring to FIG. 13, another graph is shown illustrating possible data which may be obtained and used to correlate cell size with measured metal mass in each cell. As can be seen in FIG. 13, as cell size increases there are clusters of metal levels as a function of cell size.

### EXAMPLE 4

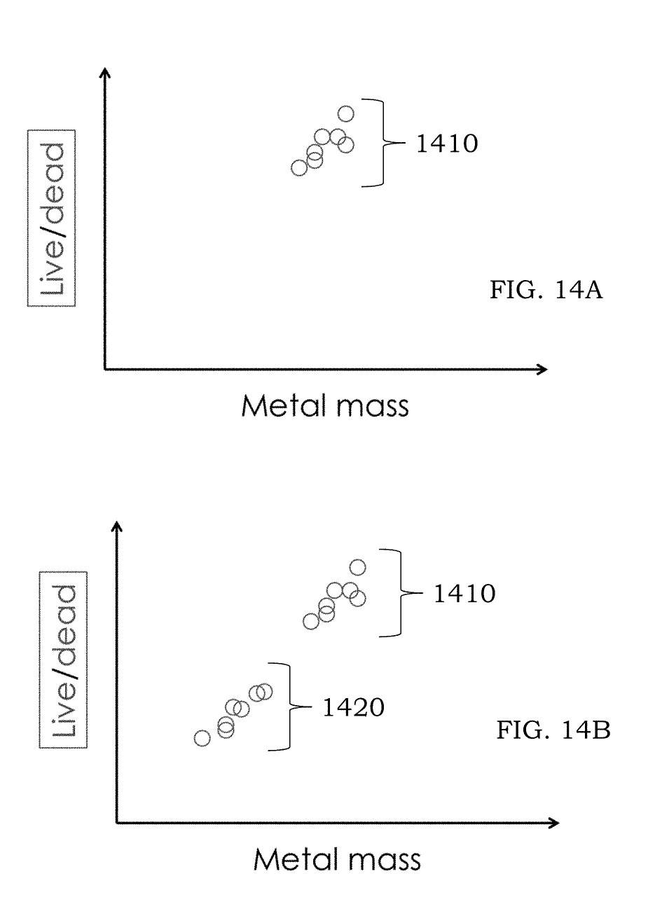

Referring to FIGS. 14A and 14B, graphs are shown of live or dead cells versus metal mass. In FIG. 14A, the live cells 1410 have higher levels of the metal. FIG. 14B shows that the dead cells 1420 have lower metal content than the live cells 1410. Whether each cell is living or dead can be determined using a flow cytometer or other cell analyzer, and the metal content of that particular cell can be determined using a mass spectrometer.

### EXAMPLE 5

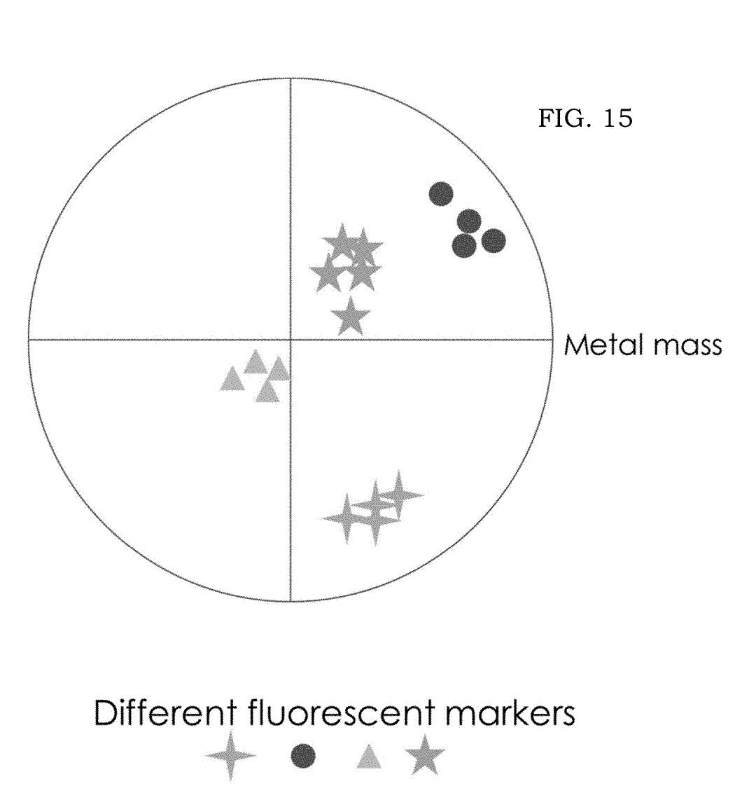

Referring to FIG. 15, graphs are shown where four different fluorescent markers (represented by the different shapes shown) are plotted against metal mass. Each of the different fluorescent markers can be, for example, present on different antibody molecules. A flow cytometer can be used to measure the presence of the fluorescent label as an indicator that the antibody bound to the cell. Each individual cell can then be provided to a mass spectrometer to determine an amount of the metal in the cell. The data can be correlated as shown in FIG. 15.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, configurations, examples and embodiments have been described above, it will be recognized by the person of ordinary skill in the art, given the benefit of this disclosure, that additions, substitutions, modifications, and alterations of the disclosed illustrative aspects, configurations, examples and embodiments are possible.

1. A method comprising:
providing an individual cell in a cell population from a cell analyzer to a mass spectrometer to quantify an amount of at least a first element in the provided individual cell; and
correlating the quantified amount of the first element in the provided individual cell with a measurement of the individual cell from the cell analyzer.

2. The method of claim 1, further comprising quantifying an amount of the first element in each cell of the cell population using the mass spectrometer and correlating the quantified amount of the first element in each of the cells with individual cell measurements from the cell analyzer.

3. The method of claim 2, further comprising using the quantified amount of the first element in each of the cells and the individual cell measurements from the cell analyzer to determine a number of the cells in the cell population that comprise the first element.

4. The method of claim 2, further comprising using the quantified amount of the first element in each of the cells and the individual cell measurements from the cell analyzer to determine a number of the cells in the cell population exhibiting a selected biological response.

5. The method of claim 2, further comprising using the quantified amount of the first element in each of the cells and the individual cell measurements from the cell analyzer to correlate cell size with the quantified amount of the first element.

6. The method of claim 2, further comprising quantifying at least a second element in each cell of the cell population.

7. The method of claim 1, further comprising configuring the cell population as a unicellular suspension prior to providing the unicellular suspension to the cell analyzer.

8. The method of claim 7, further comprising configuring the cell analyzer to provide unicellular eukaryotic cells to the mass spectrometer or unicellular prokaryotic cells to the mass spectrometer.

9. The method of claim 8, further comprising configuring the cell analyzer as a flow cytometer.

10. The method of claim 8, further comprising configuring the cell analyzer as a fluorescence activated cell sorter.

11. The method of claim 8, further comprising configuring the cell analyzer as a magnetic sorter.

12. The method of claim 9, further comprising configuring the mass spectrometer to comprise an inductively coupled plasma.

13. The method of claim 12, further comprising separating the cell population from other species using chromatography prior to providing the cell population to the cell analyzer.

14. The method of claim 12, further comprising determining cell size as the measurement of the individual cell from the cell analyzer.

15. The method of claim 12, further comprising determining cell viability as the measurement of the individual cell from the cell analyzer.

16. The method of claim 12, further comprising determining cell phenotype using a specific label as the measurement of the individual cell from the cell analyzer.

17. The method of claim 12, further comprising determining cell health using a specific label as the measurement of the individual cell from the cell analyzer.

18. The method of claim 1, further comprising configuring the cell population to comprise an average size between 0.2 microns and 100 microns, configuring the cell analyzer as a flow cytometer and configuring the mass spectrometer to comprise an inductively coupled plasma.

19. The method of claim 1, further comprising isolating organelles from the cell population, providing an individual organelle from the isolated organelles to a mass spectrometer from the cell analyzer to quantify an amount of the first element in the provided individual organelle, and correlating the quantified amount of the first element in the individual organelle with a measurement of the individual organelle from the cell analyzer.

20. The method of claim 1, further comprising using a processor to correlate the quantified amount of the at least first element in the provided individual cell with the measurement of the individual cell from the cell analyzer.

21-45. (canceled)
